(19) United States
(12) Patent Application Publication
(10) Pub. No.: US 2025/0172357 A1
(43) Pub. Date: May 29, 2025

(54) COMPOSITE RADIATIVE COOLING MATERIALS

(71) Applicant: SkyCool Systems, Inc., Mountain View, CA (US)

(72) Inventors: Gary H. Wiseman, Menlo Park, CA (US); Lee Boman, Belmont, CA (US); Eli A. Goldstein, Brisbane, CA (US); Aaswath Raman, Mountain View, CA (US)

(21) Appl. No.: 18/963,366

(22) Filed: Nov. 27, 2024

Related U.S. Application Data
(60) Provisional application No. 63/631,913, filed on Apr. 9, 2024.
(60) Provisional application No. 63/604,148, filed on Nov. 29, 2023.

(51) Int. Cl. F28F 13/18; B32B 5/18; B32B 27/06; B32B 37/12; C09J 5/00

(52) U.S. Cl. CPC F28F 13/18; B32B 5/18; B32B 27/065; B32B 37/12; C09J 5/00; B32B 2255/102; B32B 2255/26; B32B 2266/0214; B32B 2266/102; B32B 2266/104; B32B 2305/026; B32B 2307/304; B32B 2307/7376; F28F 2245/06; F28F 2255/06

(57) ABSTRACT

A composite radiative cooling material includes a first layer including a reflective material, a second layer including a porous material, and a third layer including an emissive material. The optical properties of the respective materials and the arrangement of the respective layers cause the radiative cooling material to exhibit a total solar reflectance greater than 85%, and a thermal emissivity greater than 85% in a wavelength range of 8 to 13 μm. The layers may be in a vertically stacked arrangement, with the third layer capable of directly facing the sky when the composite radiative cooling material is installed for cooling a load, the second layer arranged under the third layer, and the first layer arranged under the second layer. The composite radiative cooling material may be thermally coupled to a cooling load to provide radiative cooling to the cooling load.

### CROSS REFERENCE TO RELATED APPLICATIONS

This application claims the benefit of U.S. Provisional Patent Application No. 63/604,148, filed Nov. 29, 2023, and U.S. Provisional Patent Application No. 63/631,913, filed Apr. 9, 2024, the disclosures of which are hereby incorporated by reference herein in their entireties.

### BACKGROUND

A radiative cooling material may exhibit optical properties, including reflectivity of incoming solar radiation and emissivity of infrared radiation, that make it capable of cooling a load. Radiative cooling materials may be used in place of more energy-intensive cooling solutions, and radiative cooling materials may also be used to improve the efficiency of such energy-intensive cooling solutions.

### SUMMARY

The present disclosure is directed to composite radiative cooling materials. More specifically, the present disclosure is directed to composite radiative cooling materials that exhibit reflective (e.g., of solar radiation) and emissive (e.g., of infrared energy) properties that are suitable for cooling a cooling load.

A composite radiative cooling material may be used for cooling applications. For example, the composite radiative cooling material may incorporate or integrate various materials with suitable reflectivity in the ultraviolet (UV) and visible portions of the electromagnetic spectrum and with suitable thermal emissivity in the infrared portion of the electromagnetic spectrum. In some embodiments, the composite radiative cooling material includes three layers, of which a top layer is an emissive layer, a middle layer is a porous layer, and a bottom layer is a reflective layer. The composite radiative cooling material may provide cooling by being applied directly to a surface (e.g., to cool anything on the opposite side of the surface, such as the interior of a building or a vehicle, electronics, or any other heat-generating equipment). The composite radiative cooling material may also provide cooling by being thermally coupled to a heat exchanger, coolant fluid, thermal storage, or any combination thereof, with the heat exchanger, coolant fluid, thermal storage, or any combination thereof being thermally coupled to any suitable cooling load.

In accordance with embodiments of the present disclosure, a composite radiative cooling material includes a first layer including a reflective material, a second layer including a porous material, and a third layer including an emissive material. The composite radiative cooling material exhibits a total solar reflectance greater than 85%, and a thermal emissivity greater than 85% in a wavelength range of 8 to 13 μm (e.g., which may refer to exactly 8.0-13.0 μm, inclusive, or to approximately 8.0-13.0 μm). The layers may be in a vertically stacked arrangement, with the third layer arranged to be capable of directly facing the sky (e.g., when installed for radiative cooling), the second layer arranged under the third layer, and the first layer arranged under the second layer. The composite radiative cooling material may be thermally coupled to a cooling load to provide radiative cooling to the cooling load. The cooling load may be inside a building, vehicle, or enclosure, and the composite radiative cooling material may provide radiative cooling due to being arranged on a sky-facing surface of the building, vehicle, or enclosure. A method for arranging the composite radiative cooling material includes arranging the third layer over the second layer and arranging the second layer over the first layer. A method for cooling a load using a composite radiative cooling includes thermally coupling the composite radiative cooling material to the load and causing the radiative cooling material to cool the load based on the total solar reflectance and based on the thermal emissivity.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 shows an illustrative composite radiative cooling material in accordance with some embodiments of the present disclosure;

FIG. 2 shows illustrative and wavelength-dependent reflectance, transmittance, and absorbance exhibited by a first illustrative porous material in accordance with some embodiments of the present disclosure;

FIG. 3 shows illustrative and wavelength-dependent reflectance, transmittance, and absorbance exhibited by a second illustrative porous material in accordance with some embodiments of the present disclosure;

FIG. 4 shows illustrative and wavelength-dependent reflectance, transmittance, and absorbance exhibited by a third illustrative porous material in accordance with some embodiments of the present disclosure;

FIG. 5 shows illustrative and wavelength-dependent transmittance exhibited by a group of illustrative transparent and emissive materials in accordance with some embodiments of the present disclosure;

FIG. 6 shows illustrative and wavelength-dependent transmittance exhibited by illustrative ultraviolet absorber (UVA) materials in accordance with some embodiments of the present disclosure;

FIG. 7 shows illustrative and wavelength-dependent reflectance of an illustrative 100 μm ultra-high molecular weight polyethylene (UHMWPE) layer in accordance with some embodiments of the present disclosure;

FIG. 8 shows illustrative and wavelength-dependent reflectances for two types of UHMWPE films in accordance with some embodiments of the present disclosure;

FIG. 9A shows illustrative and wavelength-dependent reflectances of UHMWPE layers based on the stacking of a smaller pore film onto a larger pore film in accordance with some embodiments of the present disclosure;

FIG. 9B shows illustrative and wavelength-dependent reflectances of UHMWPE layers based on the stacking of sublayers within each of the layers in accordance with some embodiments of the present disclosure;

FIG. 10 shows illustrative total solar reflectances of illustrative UHMWPE layers as a function of the total layer thickness in accordance with some embodiments of the present disclosure;

FIG. 11 shows illustrative cross-sectional schematics of composite radiative cooling materials in accordance with some embodiments of the present disclosure;

FIG. 12 shows an illustrative cross-sectional schematic of a composite radiative cooling material including a porous layer with multiple porous sublayers in accordance with some embodiments of the present disclosure;

FIG. 13 shows an illustrative cross-sectional schematic of a composite radiative cooling material including a mirror film in accordance with some embodiments of the present disclosure;

FIG. 14 shows illustrative cross-sectional schematics of various arrangements of composite radiative cooling materials in accordance with some embodiments of the present disclosure;

FIG. 15 shows an illustrative cross-sectional schematic of a composite radiative cooling material including a multi-film top layer in accordance with some embodiments of the present disclosure;

FIG. 16 shows an illustrative cooling system including a composite radiative cooling material in accordance with some embodiments of the present disclosure;

FIG. 17 shows an illustrative method for arranging layers of a composite radiative cooling material in accordance with some embodiments of the present disclosure; and

FIG. 18 shows an illustrative method for radiative cooling using a composite radiative cooling material in accordance with some embodiments of the present disclosure.

### DETAILED DESCRIPTION

Radiative cooling may refer to any technique that uses a material's radiative properties to provide cooling. In order to achieve daytime radiative cooling, materials can be highly reflective in the UV, visible, and near infrared regions of the solar spectrum and thermally emissive in the infrared portion of the electromagnetic spectrum. While many materials will naturally provide some amount of radiation and thermal emission, certain materials, including some of the composite radiative cooling materials provided in embodiments of the present disclosure, may be configured to provide enough thermal emission to reduce the temperature of a load, a coolant fluid, a heat exchange interface, any other matter, or any combination thereof. For example, certain composite radiative cooling materials provided in embodiments of this disclosure may provide sufficient reflectivity of solar radiation and emissivity of infrared energy to support cooling applications. In some embodiments, the composite radiative cooling materials provide sub-ambient cooling (i.e., the composite radiative cooling material may be configured to achieve a lower temperature than the surrounding air when exposed to the sky).

In contrast to cooling techniques relying on condensers, compressors, evaporators, heat pumps, other energy-intensive equipment, or any combination thereof, radiative cooling materials can provide heat rejection with less (and possibly negligible) ongoing energy input requirements. Moreover, radiative cooling materials can be used with condensers, compressors, evaporators, heat pumps, other energy-intensive equipment, or any combination thereof to improve the efficiency of such equipment. Therefore, composite radiative cooling materials of this disclosure may be provided for environmentally-friendly and energy-conscious cooling applications, among other cooling applications.

In fact, composite radiative cooling materials of this disclosure may serve many diverse cooling systems and applications. For example, a composite radiative cooling material may be applied over a surface of a building, vehicle, enclosure, other confined space, or any combination thereof, and may then cool the inside of the building, vehicle, enclosure, other confined space, or any combination thereof. For another example, a composite radiative cooling material may be thermally coupled to a heat exchanger and may then cool a load that is also thermally coupled to the heat exchanger. Similarly, a composite radiative cooling material may be thermally coupled to a coolant fluid and may then cool a load that is also thermally coupled to the coolant fluid.

In some embodiments, composite radiative cooling materials of the present disclosure may be used for passive cooling (i.e., electricity, fuel, other input energy, or any combination thereof need not be applied to the radiative cooling material, although input energy may be required for other supporting components of a radiative cooling system, such as to pump a coolant fluid that is thermally coupled to the radiative cooling material). Composite radiative cooling materials of this disclosure may exhibit high reflectivity (e.g., greater than 75% total solar reflectance) in the solar portion of the electromagnetic energy spectrum (the “solar spectrum”) and may exhibit high thermal emissivity (e.g., greater than 85%) in the infrared portion of the electromagnetic energy spectrum. The thermal emissivity may be specifically configured to exhibit high performance in the “sky window” of the electromagnetic energy spectrum (e.g., from approximately 8 μm to approximately 13 μm).

In some embodiments, composite radiative cooling materials of this disclosure exhibit high reflectivity in the solar spectrum and high emissivity in the sky window based on the integration and arrangement of a composite material structure including at least one highly reflective material and at least one highly emissive material. Such composite radiative cooling materials may be arranged to provide high cooling power, tunable mechanical properties and form factors, long outdoor lifetimes, optical properties that are optimized for specific radiative cooling applications, or any combination thereof.

In some embodiments of the present disclosure, composite radiative cooling materials are arranged to exhibit optical properties that are suited to various radiative cooling applications. These composite radiative cooling materials may include a stack of multiple layers, where each layer may include a stack of multiple sublayers. The composite radiative cooling materials may include particular porous materials (e.g., nanoporous or microporous materials) among other materials such as reflectors, mirrors, substrates, adhesives, protective materials, emissive materials, or any combination thereof. Each respective material may be configured as a layer (or as a sublayer) of the composite radiative cooling material. As mentioned, these composite radiative cooling materials are generally provided for use in radiative cooling applications (e.g., they may be applied to any system for cooling or as part of any suitable cooling process).

In some embodiments, the porous material may be configured to exhibit a particular set of optical properties (e.g., including a target reflectivity of solar radiation and a target emissivity of infrared energy) based on configuring an average pore size, an average porosity, a number of porous layers, a thickness of the porous material, or any combination thereof. In some embodiments, respective layers of a composite radiative cooling material that includes a porous material may be arranged in a way that prevents the filling of the pores. For example, the porous material may be modified (e.g., using any suitable surface treatment) to prevent adjacent layers (i.e., materials applied directly over or directly under the porous layer) from filling the pores of the porous material. When the porous material is one layer among multiple layers of the composite radiative cooling material, the other layers of the composite radiative cooling material may be configured to provide complementary optical properties (e.g., to improve a reflectivity, emissivity, or both, of the composite radiative cooling material without significantly affecting the optical properties of the porous material).

In some embodiments, composite radiative cooling materials are arranged to include at least one layer for thermal emissivity, at least one layer for solar reflectivity, and at least one porous layer. In some embodiments, the composite radiative cooling materials are configured such that each respective layer contributes certain optical properties without significantly affecting (and, in some cases, while enhancing) the optical properties of the other layers. For example, the layers of the composite radiative cooling material may be arranged to increase the emissivity of certain high-reflectance materials (e.g., including porous materials), without significantly compromising the reflectivity of the high-reflectance material. As a result, some composite radiative cooling materials of this disclosure may exhibit a total solar reflectance greater than 85% and a thermal emissivity greater than 85% in the wavelength range of 8 to 13 μm based on specific layer materials and layer arrangements.

In some embodiments, the composite radiative cooling materials of this disclosure exhibit high reflectivity by incorporating one or more reflective porous materials. In some embodiments, the porous material is a plastic material. When using porous plastic materials within composite radiative cooling materials, numerous limitations associated with the porous material may be addressed based on suitably arranging the composite radiative cooling material. For example, some of the limits that may be addressed include, but are not limited to, the porous plastic material: exhibiting insufficient emissivity; being porous to oxygen, water, other liquids, other gases, or any combination thereof; lacking durability for outdoor use (e.g., due to UV-induced degradation); being vulnerable pore clogging (e.g., with particles, moisture, other matter, or any combination thereof), which could reduce the reflectivity of the material; or any combination thereof.

In some embodiments, various fillers (e.g., plastic fillers) may serve as suitable reflector materials for being arranged adjacent to or inside of a porous material to realize at least part of a composite radiative cooling material. In some embodiments, the composite radiative cooling material may include a voided layer with solar reflectance greater than 90% but thermal emissivity less than 50%, and a layer above the voided layer with solar absorption less than 20% and thermal emissivity greater than 80%. In some embodiments, the composite radiative cooling material includes a voided layer with solar reflectance greater than 90% but thermal emissivity less than 50%, a layer above the voided layer with solar absorption less than 20%, and an emissive layer below the voided layer with thermal emissivity greater than 80%. Based on the aforementioned two-layer and three-layer arrangements, the illustrative composite radiative cooling materials may exhibit reflectance and emissive properties which are better suited for radiative cooling than any of the layers in isolation.

In some embodiments, an emissive layer of a composite radiative cooling material may be a black emissive substrate. In some embodiments, a reflective layer of a composite radiative cooling material may include a porous film of polyethylene (PE), high molecular weight polyethylene (HMWPE), ultra-high molecular weight polyethylene (UHMWPE), polyether sulfone (PES), other porous material, or any combination thereof. In some embodiments, one or more layers (i.e., which may be referred to as adjacent layers) that are adjacent to a porous layer may be arranged above or below the porous layer in a way that reduces or eliminates absorption/adsorption of the adjacent layer materials into the pores of the porous layer.

In some embodiments, the composite radiative cooling materials include protective films (e.g., to improve a durability, hydrophobicity, anti-soiling, other suitable property, or any combination thereof) that may be applied (e.g., as a top coat (such as a hard coat), sealant, reflective layer, or any combination thereof) as a top layer (e.g., as an emissive layer, or on top of an emissive layer) of the composite radiative cooling material. For example, the protective film may be applied over a UV reflector layer of the composite radiative cooling material, and the UV reflector layer may be arranged above all other layers of the composite radiative cooling material. In some embodiments, the protective film may be visibly transparent, may include a UVA, may be thermally emissive, or may be any combination thereof. Such a protective film may, for example, be a layer or a sublayer of a composite radiative cooling material.

In some embodiments, the composite radiative cooling materials include at least one adhesive layer for mechanically coupling two other layers of the composite radiative cooling material to each other. In some embodiments, at least one aspect of the adhesive layer (e.g., thickness, material composition, curing conditions, or a combination thereof) may be configured such that the adhesive contributes to (or, at least, does not significantly detract from) optical properties (e.g., total solar reflectance greater than 85% and thermal emissivity greater than 85% in the wavelength range of 8 to 13 μm) of the composite radiative cooling material.

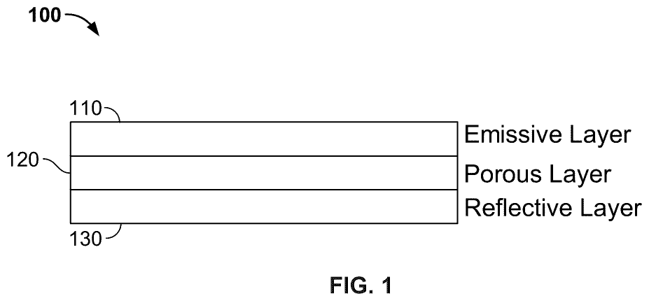

The subject matter of this disclosure may be better understood with reference to illustrative FIGS. 1-18. The subject matter of this disclosure may also be understood with reference to the following definitions, which apply to the entirety of this disclosure.

As described herein, a composite radiative cooling material may include at least one layer. As used herein, a “layer” may refer to one or more respective materials of the composite radiative cooling material. A layer is generally arranged as one or more materials with respective lengths and widths determined by the cross-sectional area of the composite radiative cooling material, and with respective thicknesses that are configured to optimize optical properties of the layer for arrangement within a composite radiative cooling material. A layer may be associated with a particular property, function, or other characteristic of the composite radiative cooling material. For example, a layer may be an emissive layer, a porous layer, a reflective layer, an adhesive layer, a mechanical coupling layer, a protective coating layer, or any suitable one or more materials that are arranged and/or configured to contribute to the cooling capabilities of the composite radiative cooling material (e.g., by providing emissivity, porosity, reflectivity, adhesion, mechanical support, protection, any other suitable properties, or any combination thereof). A layer may be associated with at least one material (e.g., a specific material, such as a type of polymer or metal, a type of material that is associated with a specific property, such as a reflective or emissive material, a porous material, or any combination thereof) and may include multiple respective materials (e.g., where at least two materials may be mixed (such as an impregnated or composite polymer), where at least two materials may be stacked upon each other, or any combination thereof). A layer may include a stack of materials (e.g., the stack having multiple films of the same material, films of respective materials, or any combination thereof). When a layer includes a stack of materials (e.g., a stack including a material that contributes desired optical properties and an adjacent adhesive material, a stack of discrete films, a stack of multiple films of a single film type, any other suitable material stack, or any combination thereof), each element of the stack may be referred to herein as a sublayer.

As used herein, a film may refer to any material that can be applied over a surface. The composite radiative cooling material may itself be a film, layers of the composite radiative cooling material may be respective films, and sublayers of the composite radiative cooling material may be respective films.

As used herein, geometric orientation terms (including, but not limited to, “top”, “bottom”, “above”, “below”, “over”, “under”, similar descriptors, or any derivatives thereof) may be used to help describe an arrangement of a composite radiative cooling material. The composite radiative cooling material may be arranged to be capable of directly facing the sky, and when facing the sky, cooling is provided based on the “top” of the material being the surface that directly faces the sky. For example, the emissive layer of the composite radiative cooling material may be arranged as the top of the material. Even when a composite radiative cooling material is, e.g., rolled up and indoors, it would maintain specific “top” and “bottom” surfaces based on the aforementioned capability, which is based on an orientation when the material is installed for its intended purpose of cooling a load.

As used herein, “reflectance” may refer to the reflectance of incident solar energy. For example, reflectance may represent the portion of incident solar energy that is not absorbed or transmitted. As used herein, total solar reflectance may refer to the total reflectance (i.e., diffuse reference plus specular reflectance) in the wavelength range of 280 nm to 2500 nm as weighted by the AM 1.5 G solar spectrum.

As used herein, optical properties may include one or more of emissivity, reflectivity, transmittance, and absorbance (noting that absorbance may be negligible, but is not necessarily negligible). As used herein, radiative (and related terms) may be used interchangeably with emissive (and related terms), and vice versa.

As used herein, a layer of a composite radiative cooling material may be “arranged and/or configured” to contribute certain optical properties. It will be understood that the layer may be arranged (e.g., with respect to other layers) to contribute certain optical properties based on optical interactions with the other layers. It will be understood that the layer may also be configured (e.g., with a certain thickness, porosity, pore size, arrangement of sublayers, surface treatment, or any combination thereof) to contribute certain optical properties based on how the configuration causes the layer to exhibit certain optical properties. To be “arranged and/or configured” means that the material is arranged, configured, or both, for contributing certain optical properties as part of a composite radiative cooling material.

As used herein, visibly transparent may refer to a material that transmits a substantial portion (e.g., over 95%) of electromagnetic emissions in the visible spectrum.

As used herein, porous may be used interchangeably with voided, and vice versa; pores may be used interchangeably with voids, and vice versa.

As used herein, a load may broadly refer to anything that can be cooled. While many example loads are provided in this disclosure, embodiments of this disclosure need not be limited to cooling any specific load. Rather, composite radiative cooling materials of this disclosure may be arranged and configured to serve any earthly cooling application. Load may be used interchangeably with cooling load, and vice versa.

FIG. 1 shows an illustrative composite radiative cooling material 100 in accordance with some embodiments of the present disclosure. Composite radiative cooling material 100 includes a top emissive layer 110, a middle porous layer 120, and a bottom reflective layer 130. While various composite radiative cooling materials of this disclosure need not have the same ordering or arrangement of layers, the positional descriptions of composite radiative cooling material 100 are based on a cooling capability of the composite radiative cooling material 100 according to an installed orientation where the top emissive layer faces the sky (i.e., the top emissive layer 110 is directly exposed to incoming solar radiation). Though not shown in FIG. 1, composite radiative cooling material 100 may also include respective adhesive layers between emissive layer 110 and porous layer 120, between porous layer 120 and reflective layer 130, or between both pairs of layers (e.g., to respectively adhere the porous layer 120 to the emissive layer 110, and/or to respectively adhere the porous layer 120 to the reflective layer 130). Moreover, composite radiative cooling material 100 may include an adhesive layer below reflective layer 130 (e.g., to mount composite radiative cooling material 100 to a substrate, to a surface to be cooled, to any other suitable interface, or to any combination thereof).

As shown, composite radiative cooling material 100 may be provided in a vertically stacked arrangement. For example, as shown, the top emissive layer 110 may be arranged to be capable (e.g., in an orientation when the material is installed for its intended purpose of cooling a load) of directly facing incoming solar radiation, with the middle porous layer 120 arranged under the top emissive layer 110, and the bottom reflective layer 130 arranged under the middle porous layer 120.

Porous layer 120 of composite radiative cooling material 100 may be any nanoporous or microporous layer described in this disclosure, such as a PE, polyethylene terephthalate (PET), UHMWPE, PET, polyether sulfone and polyamide layer, or any other suitable plastic layer, with any suitable thickness, porosity, stacking of sublayers, and average pore size. In some embodiments, the porous material is nanoporous; for example, the nanoporous material may include many pores with an average pore size between 100 nm and 1,000 nm. In some embodiments, the pores of the porous layer 120 cause the porous layer material to exhibit a porosity greater than 75%.

Table 1 shows representative materials (e.g., for use in radiative cooling material 100 as porous layer 120) that may be used as a porous layer, along with corresponding geometry and performance specifications. As listed in Table 1 and as may be referenced in other parts of this disclosure, polyethylene terephthalate glycol is abbreviated as PETg. In some embodiments, the representative materials of Table 1 are configured (e.g., to a target pore size, porosity, thickness, or any combination thereof) to be suitably reflective and to exhibit the total solar reflectance as shown. As reflected by the data of Table 1, porous layer 120 may exhibit a total solar reflectance greater than 75%, and porous layer 120 may be of a thickness that is at least 1 mil (i.e., 0.001 inch). In some embodiments, porous layer 120 is further arranged and/or configured to exhibit a total solar absorbance less than 5%.

TABLE 1
Illustrative porous layers for use in
a composite radiative cooling material

| | Pore Size | Thickness | Total Solar |
|---|---|---|---|
| Porous Layer Material | (nm) | (mil) | Reflectance |
| Porous PE | 100 | 3 | 82.4% |
| Porous PE | 100 | 6 | 90.2% |
| Porous PE | 100 | 9 | 93.2% |
| Porous PE | 100 | 12 | 90.6% |
| Porous PE | 200 | 4 | 82.8% |
| Porous PE | 200 | 8 | 90.6% |
| Porous PE | 200 | 12 | 93.5% |
| Porous PE | 200 | 16 | 94.8% |
| Porous PE | 450 | 6 | 88.0% |
| Porous PE | 450 | 12 | 93.4% |
| Porous PE | 450 | 18 | 95.6% |
| Porous PE | 450 | 14 | 96.4% |
| Porous PETg | 100-1000 | 3.6 | 81.1% |
| Porous PETg | 100-1000 | 5.4 | 85.2% |
| Porous PETg | 100-1000 | 7.2 | 88.2% |
| Porous PETg | 100-1000 | 9.1 | 89.4% |
| Porous UHMWPE | 50 | 2.4 | 81.4% |
| Porous UHMWPE | 100 | 0.8 | 74.0% |
| Porous UHMWPE | 100 | 2.4 | 89.6% |
| Porous UHMWPE | 100 | 4 | 93.6% |
| Porous UHMWPE | 500 | 4 | 88.6% |
| Porous UHMWPE | 500 | 8 | 94.2% |
| Porous UHMWPE | 500 | 12 | 96.1% |
| Porous UHMWPE | 500 | 16 | 97.2% |
| Porous UHMWPE | 500 | 20 | 97.8% |
| Porous UHMWPE | 800 | 10 | 92.8% |
| Porous UHMWPE | 800 | 20 | 96.2% |
| Porous UHMWPE | 800 | 30 | 97.4% |
| Porous PES | 30 | 4.5 | 94.0% |
| Porous PES | 100 | 4.5 | 94.5% |
| Porous PES | 200 | 4.5 | 94.6% |
| Porous PES | 450 | 4.5 | 93.4% |
| Porous PES | 650 | 4.5 | 94.2% |
| Porous PES | 800 | 4.5 | 88.2% |
| Porous PES | 1200 | 4.5 | 90.2% |
| Porous PES/Polyamide | 100 | 2 | 89.0% |
| Porous PES/Polyamide | 100 | 4 | 93.7% |

As an alternative to, or as a composite with any one or more of those illustrative materials listed in Table 1, the porous layer 120 may include high molecular weight polyethylene (HMWPE), polysulfone, or a fluorinated polymer such as polyvinylidene fluoride (PVDF), polytetrafluoroethylene (PTFE), any other fluorinated polymer, or any combination thereof.

In some embodiments, emissive layer 110 is any suitable top coat (e.g., such as a hard coat), such as a water-based urethane. For example, emissive layer 110 may be any of the top coat layers shown in Tables 2-3. In some embodiments, Tables 2-3 show how emissive layer 110 may be arranged as a top coat layer above a porous material, causing the composite radiative cooling material to exhibit an improved emissivity over that of the standalone porous material. While the improvements shown in Tables 2-3 are representative of specific combinations of a porous layer and an emissive layer, applying other types of emissive layers (e.g., including other top coat materials) to the same porous layer, or applying any emissive layer over any porous layer, may result in similar performance improvement as shown in Tables 2-3.

Tables 2-3 show representative porous layer 120 materials that may be used with a particular emissive layer 110, as listed, along with corresponding geometry and performance specifications. In some embodiments, each emissive layer 110 (e.g., which may be a top coat, such as a hard coat) of Tables 2-3 is arranged (e.g., to a target thickness, number of sublayers, or both) to cause the stack of porous layer 120 and emissive layer 110 to exhibit the emissivity values as shown. Emissive layer 110 may provide suitably emissivity for radiative cooling applications, while minimally affecting the total solar reflectance of one or more underlying layers. As listed in Table 2, the water-based urethane may be a type of thermoplastic polyurethane (TPU).

TABLE 2
Illustrative emissivity improvement by
adding a top coat over a porous layer

| Porous Layer Material, without | Emissivity | Total Solar |
|---|---|---|
| and with Emissive Layer Material | (8-13 μm) | Reflectance |
| UHMWPE (100 μm thick single | 14.5% | 89% |
| layer, with 500 nm average pore size) | | |
| UHMWPE (100 μm thick single | 85% | 86% |
| layer, with 500 nm average pore size) | | |
| plus water-based urethane top coat | | |

TABLE 3
Illustrative emissivity improvement by adding
a top coat over various porous layers

| | Total Solar | | Emissivity | |
|---|---|---|---|---|
| | Reflectance | | (8-13 μm) | |
| | No | With | No | With |
| | Hard | Hard | Hard | Hard |
| Porous Layer Material | Coat | Coat | Coat | Coat |
| UHMWPE - 100 μm thick | 89.0% | 84.2% | 17% | 93% |
| single layer, with 500 nm | | | | |
| average pore size | | | | |
| UHMWPE - five stacked | 96.9% | 89.4% | 26% | 95% |
| 100 μm thick single | | | | |
| sublayers, each with 500 | | | | |
| nm average pore size | | | | |

In connection with the data of the Tables 2-3, the hard coat layer may include two films (which may be regarded as respective sublayers) of water-based polyurethane, any other suitable resin material, or any combination thereof. In some embodiments, emissive layer 110 may be formed by deposition of an aqueous film including at least one resin material, the resin material including a resin of PVDF, polyurethane, acrylic, or any combination thereof.

Table 4 shows illustrative emissive materials for use in a composite radiative cooling material (e.g., for use in composite radiative cooling material 100 as emissive layer 110). As listed in Table 4 and as may be referenced in other parts of this disclosure, UV-protected refers to a material that is configured (e.g., impregnated or otherwise treated) to be protected from UV radiation; poly(methyl methacrylate) is abbreviated as PMMA; and the polyacrylate coating is applied via any suitable solvent. Either of the fluoropolymer coating or the polyacrylate coating can be applied over an emissive layer 110 (e.g., including any other material listed in Table 4) or over the porous layer 120 of the composite radiative cooling material 100.

TABLE 4
Illustrative emissive layers for use in a radiative cooling material

| Emissive Layer Material | Emissivity (8-13 μm) |
|---|---|
| Polycarbonate | 93.9% |
| PET Clear | 93.5% |
| PET UV-protected | 95.2% |
| Cyclic Olefin Copolymer | 95.2% |
| PVDF/PMMA composite | 94.3% |
| TPU Clear Typical UVA | 94.3% |
| TPU Clear Blue-shifted UVA | 94.3% |
| Fluoropolymer Coating | 95.0% |
| Polyacrylate Coating | 92.4% |

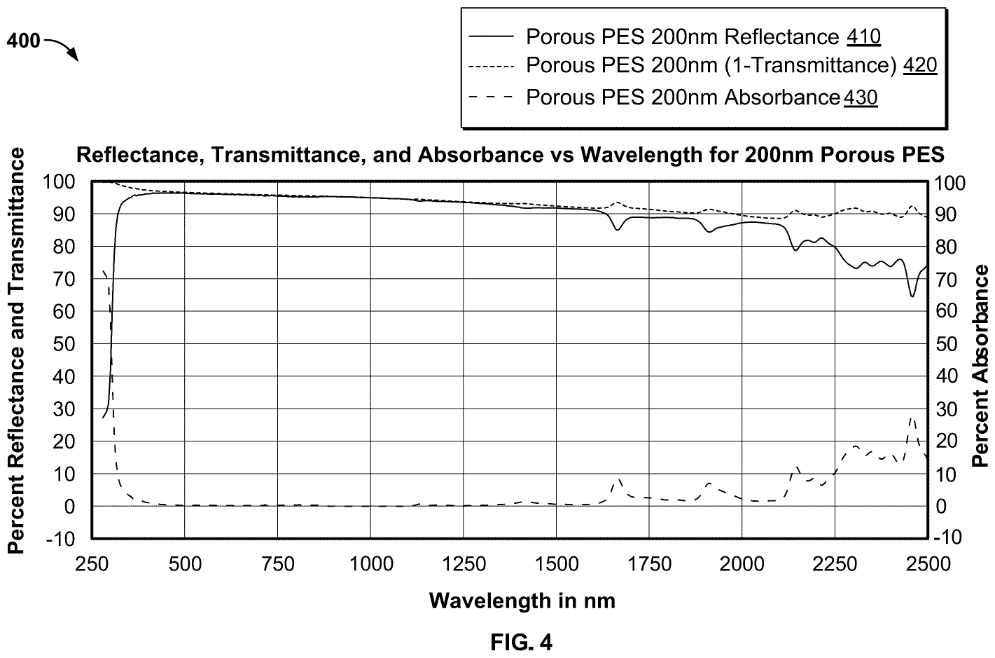

As shown, any of the illustrative emissive layers of FIG. 4 may be arranged and/or configured to exhibit a thermal emissivity greater than 85% in the wavelength range of 8 to 13 μm. In addition to the emissivity values shown in Table 4, any of those illustrative emissive layer materials (e.g., which may form emissive layer 110) may be arranged and/or configured to exhibit a total solar absorption of less than 5%.

In some embodiments, reflective layer 130 is any suitable commodity reflector, as described below, mirror film, as also described below, or other suitable reflective material. For example, reflective layer 130 may include any of the materials shown in Table 5.

Table 5 shows illustrative reflective materials (e.g., for use in radiative cooling material 100 as reflective layer 130), along with corresponding geometry and performance specifications. As listed in Table 5 and as may be referenced in other parts of this disclosure, polytetrafluoroethylene is abbreviated as PTFE; Al-on-PET refers to biaxially oriented PET with an aluminum coating (a material stack that may be used interchangeably with biaxially oriented PET with a silver coating); polyvinyl chloride is abbreviated as PVC; and thermoplastic olefin is abbreviated as TPO. In some embodiments, the representative materials of Table 5 are configured (e.g., to a target thickness) to be suitably reflective for radiative cooling applications. As shown by the data of Table 5, reflective layer 130 of composite radiative cooling material 100 may be arranged and/or configured to exhibit a total solar reflectance greater than 75%.

TABLE 5
Illustrative reflective layers of a
composite radiative cooling materials

| | Thickness | Total Solar |
|---|---|---|
| Material | (mil) | Reflectance |
| White PET | 2 | 76.3% |
| White PET | 4 | 84.0% |
| White PET | 6 | 86.8% |
| White PET | 8 | 88.4% |
| White PET | 10 | 88.7% |
| White TPU | 2 | 72.2% |
| White TPU | 4 | 79.6% |
| White TPU | 6 | 83.4% |
| White TPU | 12 | 84.3% |
| Porous PTFE | 2 | 76.1% |
| Porous PTFE | 5 | 88.4% |
| Al-on-PET | 1 | 86.2% |
| Silver solar reflective film | 1 | 87.1% |
| PVC roofing composite | Any | 83.3% |
| TPO roofing composite | Any | 77.6% |

In some embodiments, any of the cross-sectional schematics shown in FIGS. 11-15 may correspond to the arrangement of composite radiative cooling material 100, or the arrangement of composite radiative cooling material 100 with at least one additional layer.

In some embodiments, the respective layers shown in FIG. 1 can be arranged as shown and then chemically or mechanically attached to each other through application of pressure, heat, or both. In some embodiments, application of pressure, heat, or both promotes chemical bonding at layer-to-layer interfaces.

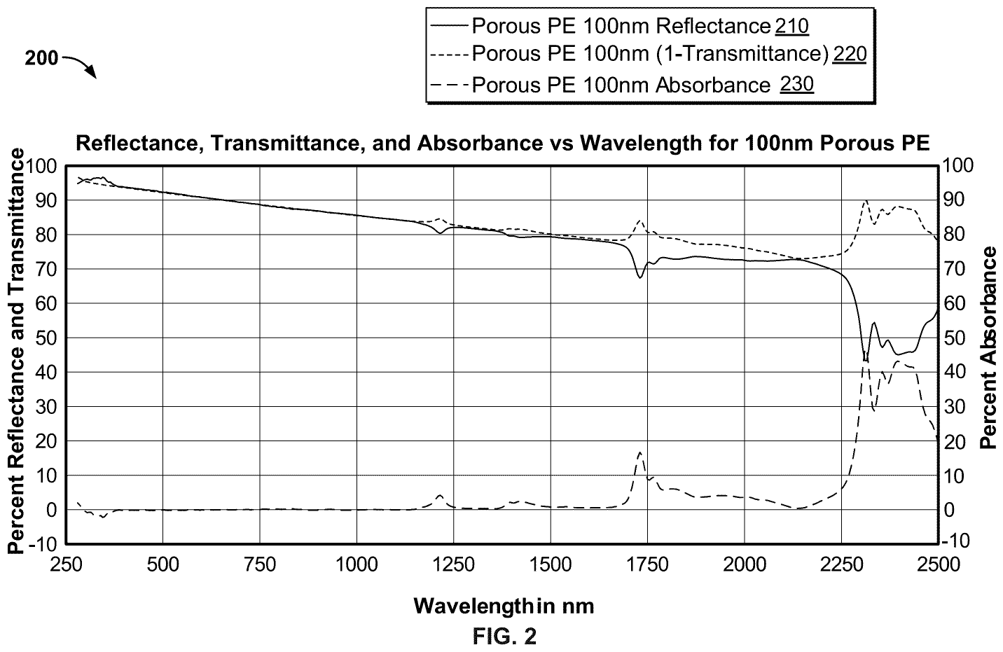

FIG. 2 shows illustrative and wavelength-dependent reflectance, transmittance, and absorbance exhibited by a first illustrative porous material in accordance with some embodiments of the present disclosure. The material shown in depiction 200 is porous PE with an average pore size of 100 nm. Curve 210 shows the wavelength-dependent reflectance of the porous PE. Curve 220 shows the wavelength-dependent transmittance (plotted as 1−transmittance, for ease of interpretation) of the porous PE; as shown, the transmittance of the porous PE is less than 30% across the 250 nm-2500 nm wavelength range shown in FIG. 2. Curve 230 shows the wavelength-dependent absorbance of the porous PE (e.g., calculated as the difference of 1−transmittance−reflectance). Curve 230 shows how the absorbance of the porous PE is at or near zero across much of the 250 nm-2500 nm wavelength range shown in FIG. 2.

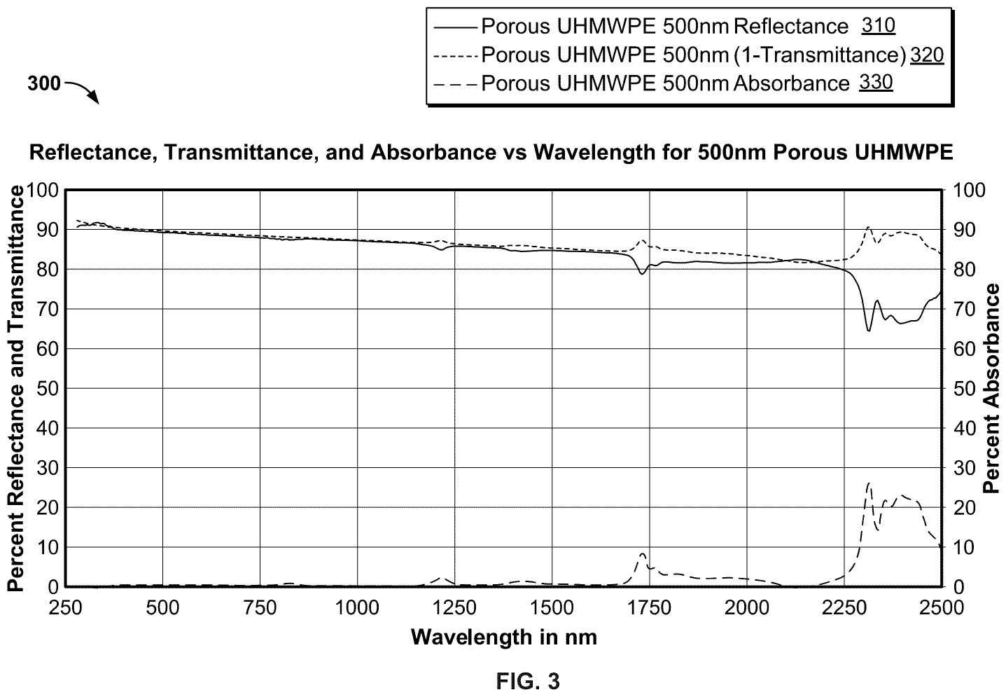

FIG. 3 shows illustrative and wavelength-dependent reflectance, transmittance, and absorbance exhibited by a second illustrative porous material in accordance with some embodiments of the present disclosure. The material shown in depiction 300 is porous UHMWPE with an average pore size of 500 nm. Curve 310 shows the wavelength-dependent reflectance of the porous UHMWPE. Curve 320 shows the wavelength-dependent transmittance (plotted as 1−transmittance, for ease of interpretation) of the porous UHMWPE; as shown, the transmittance of the porous UHMWPE is less than 30% across the 250 nm-2500 nm wavelength range shown in FIG. 3. Curve 330 shows the wavelength-dependent absorbance of the porous UHMWPE (e.g., calculated as the difference of 1−transmittance−reflectance). Curve 330 shows how the absorbance of the porous UHMWPE is at or near zero across much of the 250 nm-2500 nm wavelength range shown in FIG. 3.

FIG. 4 shows illustrative and wavelength-dependent reflectance, transmittance, and absorbance exhibited by a third illustrative porous material in accordance with some embodiments of the present disclosure. The material shown in depiction 400 is porous PES with an average pore size of 200 nm. Curve 410 shows the wavelength-dependent reflectance of the porous PES. Curve 420 shows the wavelength-dependent transmittance (plotted as 1−transmittance, for ease of interpretation) of the porous PES; as shown, the transmittance of the porous PES is less than 15% across the 250 nm-2500 nm wavelength range shown in FIG. 4. Curve 430 shows the wavelength-dependent absorbance of the porous PES (e.g., calculated as the difference of 1−transmittance−reflectance). Curve 430 shows how the absorbance of the porous PES is at or near zero across much of the 250 nm-2500 nm wavelength range shown in FIG. 4.

In some embodiments, composite radiative cooling materials of this disclosure, or at least one layer thereof, may exhibit the wavelength-dependent optical properties shown in FIG. 2, FIG. 3, or FIG. 4. Any of the materials with properties exhibited in FIGS. 2-4 may be a whole or part of porous layer 120.

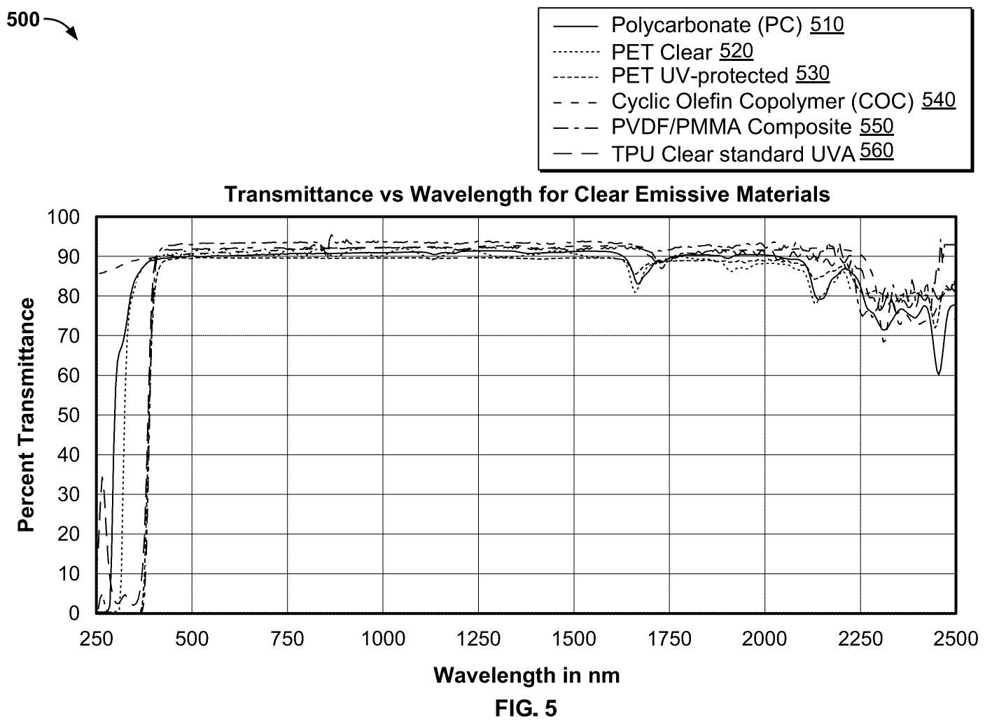

FIG. 5 shows illustrative and wavelength-dependent transmittances exhibited by a group of illustrative transparent emissive materials in accordance with some embodiments of the present disclosure. For example, any of the materials with properties exhibited in illustrative depiction 500 may be a whole or part of emissive layer 110. In some embodiments, the materials with properties exhibited in FIG. 5 also exhibit the corresponding emissivity values listed in Table 4. Within illustrative depiction 500, curve 510 shows an illustrative wavelength-dependent transmittance of polycarbonate; curve 520 shows an illustrative wavelength-dependent transmittance of clear PET; curve 530 shows an illustrative wavelength-dependent transmittance of UV-protected PET; curve 540 shows an illustrative wavelength-dependent transmittance of cyclic olefin copolymer (COC); curve 550 shows an illustrative wavelength-dependent transmittance of a PVDF/PMMA composite; and curve 560 shows an illustrative wavelength-dependent transmittance of TPU with a UVA.

Considering at least the materials referenced in Table 4 and FIG. 5, an emissive material (e.g., for use in emissive layer 110) can have suitably high solar transmittance while also including a UVA, which may be applied as an additive to the emissive material, as an additive to another material, or as a discrete film. The optical properties of such a UVA can be configured to complement those of the emissive layer material, the porous material, the reflective material, or any combination thereof, so as to provide sufficient UV-blocking to protect those materials from rapid weathering in outdoor applications without absorbing much solar radiation.

In some embodiments, chemically bonded UVAs can be added to an emissive layer 110, to an adhesive layer, to another suitable layer of a composite radiative cooling material, or to any combination thereof to reduce the amount of UV light that penetrates the composite material (e.g., to provide protection against UV-induced damage of the material layers).

In some embodiments, composite radiative cooling materials of this disclosure, or at least one layer thereof, may exhibit one of the wavelength-dependent transmittances shown in FIG. 5. Any of the materials with properties exhibited in FIG. 5 may be a whole or part of emissive layer 110.

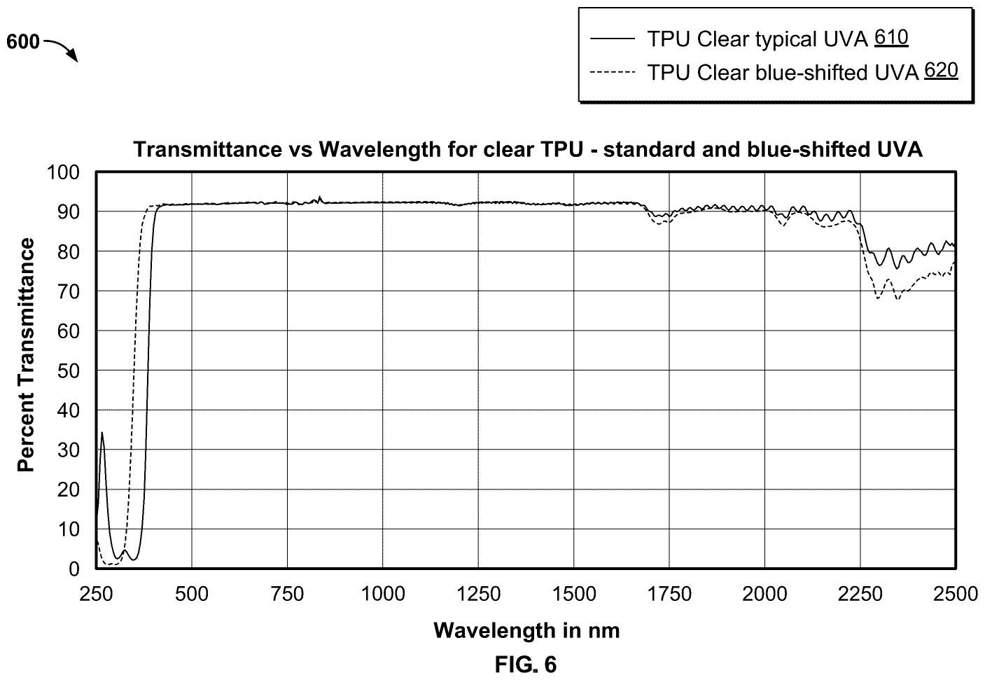

FIG. 6 shows illustrative and wavelength-dependent transmittance exhibited by illustrative UVA materials in accordance with some embodiments of the present disclosure. While some composite radiative cooling materials of the present disclosure include a typical UVA (e.g., as depicted by curve 610) in the emissive layer, other composite radiative cooling materials include a blue-shifted (i.e., exhibiting an onset of UV absorption at a lower wavelength than a non-blue-shifted material) UVA (e.g., as depicted in curve 620) to improve the total solar reflectance of the composite films (e.g., which may be a whole or a part of a composite radiative cooling material) while still providing adequate UV protection for long outdoor lifetime. Curve 610 shows an illustrative transmission spectrum of a TPU emissive layer with a conventional UVA (e.g., which may, in some embodiments, correspond to emissive layer 110), which exhibits transmittance above 90% at wavelengths above 405 nm and which exhibits transmittance below 5% at wavelengths below 365 nm. Curve 620 shows an illustrative transmission spectrum of a TPU emissive layer with a blue-shifted UVA (e.g., which may, in some embodiments, correspond to emissive layer 110), which exhibits transmittance above 90% at wavelengths above 380 nm which exhibits transmittance below 5% at wavelengths below 325 nm.

In some embodiments, composite radiative cooling materials of this disclosure, or at least one layer thereof, may exhibit one of the wavelength-dependent transmittances shown in FIG. 6. Any of the materials of FIG. 6 may be a whole or part of emissive layer 110.

In some embodiments, composite radiative cooling material 100 or other radiative cooling materials provided according to the subject matter of this disclosure exhibit improved total solar reflectance (e.g., compared to a corresponding material with no UVA or with a typical UVA) by using blue-shifted UVA as a protective material.

In some embodiments, composite radiative cooling material 100 or other radiative cooling materials provided according to the subject matter of this disclosure may be assembled by hot-nip lamination of the respective layers into a composite material. This assembly process may or may not include applying at least one adhesive material between respective layers. Illustrative adhesive materials that may be included as part of any composite radiative cooling material include acrylic adhesives and silicone adhesives. In some embodiments, one or more of the layers (e.g., any one or more of emissive layer 110, porous layer 120, or reflective layer 130) may be treated with a corona treatment, plasma treatment, chemical treatment, other surface treatment, or any combination thereof to modify a surface of the layer and improve its bond strength to an adhesive material.

Illustrative composite radiative cooling materials may include various arrangements of emissive layer 110, porous layer 120, and reflective layer 130. Table 6 shows some illustrative arrangements of composite radiative cooling material 100 and corresponding optical properties. In Table 6 and as may be provided in other parts of this disclosure, a pore size is reported in nm and a thickness is reported in mil. For one illustrative example, “PE 450 nm/12-mil” indicates a polyethylene film with average pore size of 450 nm and thickness of 12 mil.

TABLE 6
Illustrative composite radiative cooling materials

| Composite | Emissive | Porous Layer | Reflective | Total Solar | Emissivity |
|---|---|---|---|---|---|
| Material # | Layer 110 | 120 | Layer 130 | Reflectance | (8-13 μm) |
| 1 | Polycarbonate | PE 450 nm/12-mil | White PET | 95.5% | 91.8% |
| 2 | PET Clear | PE 450 nm/12-mil | White PET | 93.5% | 86.8% |
| 3 | PET UV- | PE 450 nm/12-mil | White PET | 90.6% | 89.5% |
| | Protected | | | | |
| 4 | COC | PE 450 nm/12-mil | White PET | 95.2% | 72.0% |
| 5 | PVDF/PMMA | PE 450 nm/12-mil | White PET | 90.3% | 94.0% |
| | Composite | | | | |
| 6 | TPU Clear std | PE 450 nm/12-mil | White PET | 90.4% | 86.4% |
| | UVA | | | | |
| 7 | TPU Clear | PE 450 nm/12-mil | White PET | 93.7% | 93.9% |
| | blue-shift | | | | |
| | UVA | | | | |
| 8 | TPU Clear std | UHMWPE | White TPU | 89.0% | 92.6% |
| | UVA | 500 nm/4-mil | | | |
| 9 | TPU Clear | UHMWPE | White TPU | 91.9% | 93.5% |
| | blue-shift | 500 nm/4-mil | | | |
| | UVA | | | | |
| 10 | TPU Clear std | UHMWPE | White TPU | 91.1% | 91.4% |
| | UVA | 500 nm/8-mil | | | |
| 11 | TPU Clear | UHMWPE | White TPU | 94.1% | 92.9% |
| | blue-shift | 500 nm/8-mil | | | |
| | UVA | | | | |
| 12 | TPU Clear std | UHMWPE | White TPU | 90.4% | 91.2% |
| | UVA | 800 nm/10-mil | | | |
| 13 | TPU Clear | UHMWPE | White TPU | 93.3% | 92.9% |
| | blue-shift | 800 nm/10-mil | | | |
| | UVA | | | | |
| 14 | TPU Clear | PES/Polyamide | Al-on-PET | 92.4% | 94.4% |
| | blue-shift | 100 nm/4-mil | | | |
| | UVA | | | | |
| 15 | TPU Clear | PETg 100- | Al-on-PET | 88.4% | 93.9% |
| | blue-shift | 1000 nm/9.1-mil | | | |
| | UVA | | | | |
| 16 | TPU Clear | PES 200 nm/4.5- | Al-on-PET | 93.7% | 94.0% |
| | blue-shift | mil | | | |
| | UVA | | | | |
| 17 | TPU Clear | PES 200 nm/4.5- | Porous PTFE | 94.2% | 94.0% |
| | blue-shift | mil | | | |
| | UVA | | | | |
| 18 | TPU Clear | PES 200 nm/4.5- | Silver Solar | 95.5% | 94.2% |
| | blue-shift | mil | Reflective | | |
| | UVA | | film | | |
| 19 | TPU Clear | PES 200 nm/4.5- | PVC Roofing | 93.8% | 94.3% |
| | blue-shift | mil | composite | | |
| | UVA | | | | |
| 20 | TPU Clear | PES 200 nm/4.5- | TPO Roofing | 91.7% | 94.6% |
| | blue-shift | mil | Composite | | |
| | UVA | | | | |

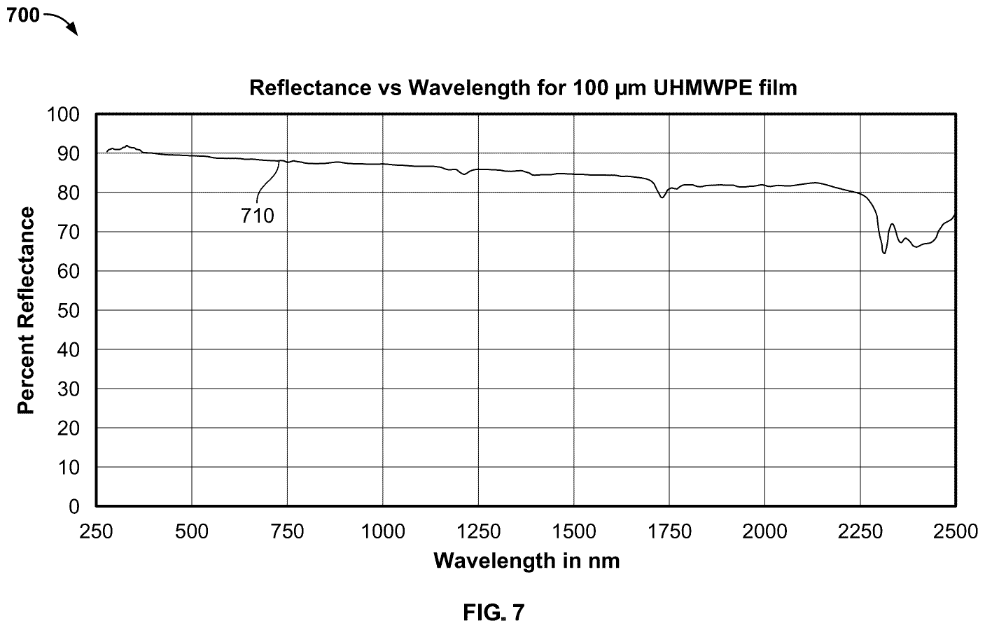

FIG. 7 shows illustrative and wavelength-dependent reflectance of an illustrative 100 μm UHMWPE layer in accordance with some embodiments of the present disclosure. Curve 710 of FIG. 7 shows how a single UHMWPE layer (e.g., porous layer 120) of a composite radiative cooling material may reflect greater than 90% of solar energy in the UV portion of the electromagnetic spectrum, may reflect close to 90% (e.g., greater than 85%) of solar energy in the visible portion of the electromagnetic spectrum, and may reflect greater than 80% of solar energy in the infrared portion of the electromagnetic spectrum. In some embodiments, curve 710 may correspond to curve 310.

In some embodiments, composite radiative cooling materials of this disclosure, or at least one layer thereof, may exhibit the wavelength-dependent reflectance shown in FIG. 7.

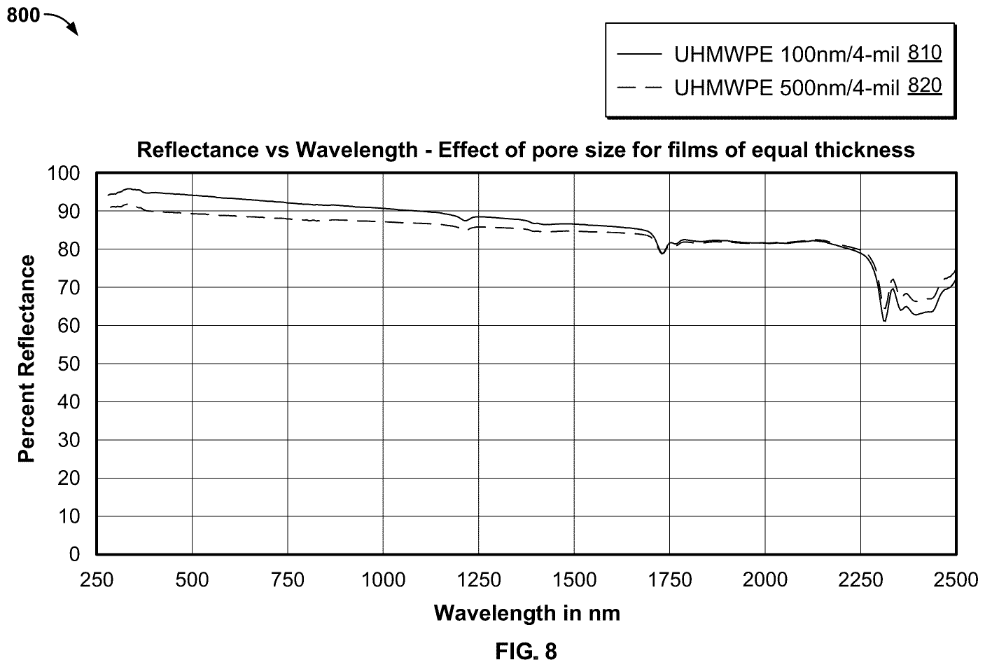

FIG. 8 shows illustrative and wavelength-dependent reflectance for two types of UHMWPE films in accordance with some embodiments of the present disclosure. Curve 810 shows the wavelength-dependent reflectance of a 4 mil thick UHMWPE film with a 100 nm average pore size. Curve 820 shows the wavelength-dependent reflectance of a 4 mil thick UHMWPE film with a 500 nm average pore size. In this illustrative comparison, the film with 100 nm pore size outperforms (e.g., has a greater reflectance than) the film with 500 nm pore size.

In some embodiments, composite radiative cooling materials of this disclosure, or at least one layer thereof, may exhibit one of the wavelength-dependent reflectances shown in FIG. 8. Any of the materials with properties exhibited in FIG. 8 may be a whole or part of porous layer 120.

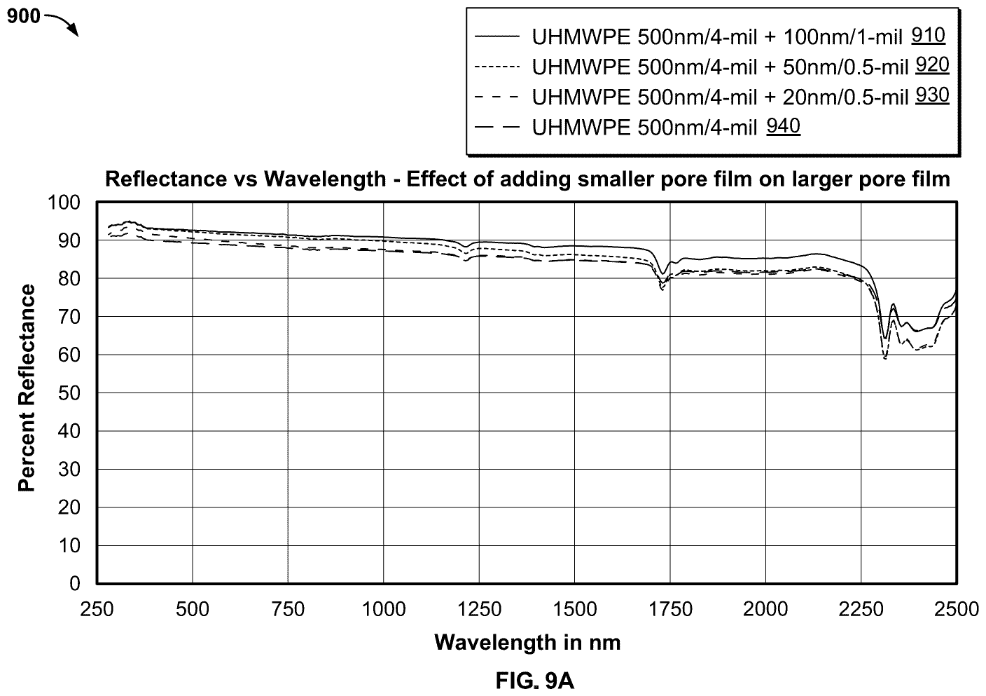

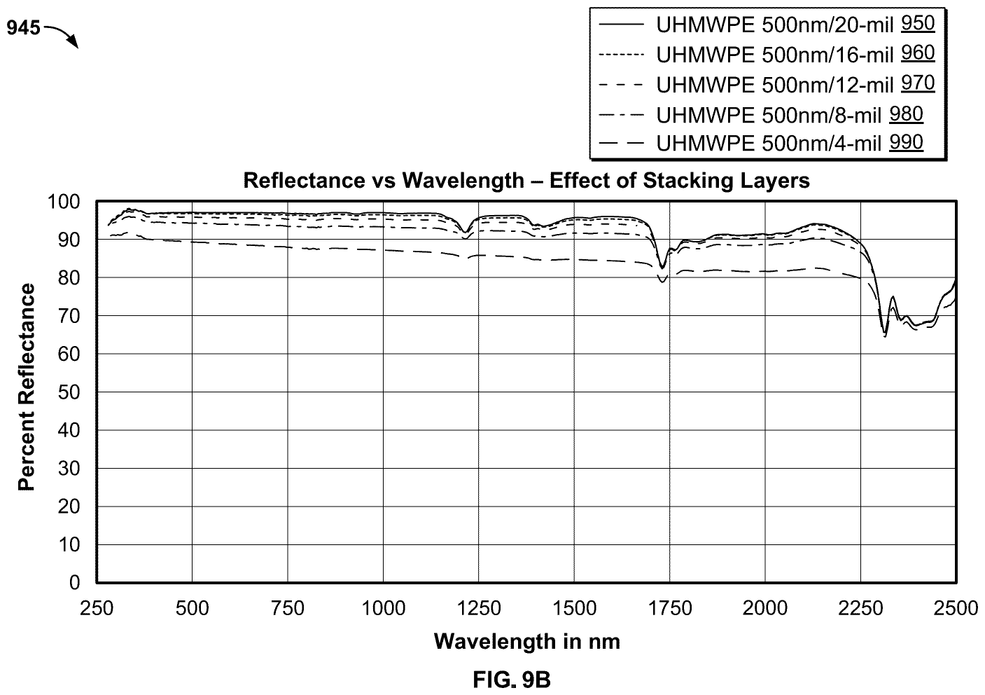

FIG. 9A shows illustrative and wavelength-dependent reflectances of UHMWPE layers based on the stacking of a smaller pore film (e.g., having an average pore size of 100 nm or less) onto a larger pore film (e.g., having an average pore size of 500 nm) within each of the layers in accordance with some embodiments of the present disclosure. The depiction 900 shows illustrative performance data associated with the following porous layers: (i) curve 910 corresponds to a layer that includes a first sublayer of a 4 mil thick UHMWPE film with an average pore size of 500 nm and a second sublayer of a 1 mil thick UHMWPE film with an average pore size of 100 nm; (ii) curve 920 corresponds to a layer that includes a first sublayer of a 4 mil UHMWPE film with an average pore size of 500 nm and a second sublayer of a 0.5 mil thick UHMWPE film with a typical pore size of 50 nm; (iii) curve 930 corresponds to a layer that includes a first sublayer of a 100 μm UHMWPE film with an average pore size of 500 nm and a second sublayer of a 0.5 mil thick UHMWPE film with an average pore size of 20 nm; and (iv) curve 940 corresponds to a layer that includes a 100 μm UHMWPE film with an average pore size of 500 nm. In this illustrative comparison, the films with two sublayers outperform (e.g., have a greater reflectance than) the single film.

FIG. 9B shows depiction 945 of the illustrative wavelength-dependent reflectance of illustrative stackings of multiple 4 mil thick UHMWPE films in accordance with some embodiments of the present disclosure. The respective curves of depiction 945 correspond to varying numbers of UHMWPE films. Curve 950 shows illustrative reflectance properties of a single 4 mil thick UHMWPE film, curve 960 shows illustrative reflectance properties of a layer including a stacking of two 4 mil thick UHMWPE sublayers, curve 970 shows illustrative reflectance properties of a layer including a stacking of three 4 mil thick UHMWPE sublayers, curve 980 shows illustrative reflectance properties of a layer including a stacking of four 4 mil thick UHMWPE sublayers, and curve 990 shows illustrative reflectance properties of layer including a stacking of five 4 mil thick UHMWPE sublayers.

The reflectance properties of depiction 945 together show how the reflectance of a radiative cooling material can increase upon stacking multiple UHMWPE films or sublayers. In some embodiments, each of the multiple sublayers has a same (or substantively similar) porosity or a same pore size; in other embodiments, at least two of the multiple sublayers have respective porosities or respective pore sizes (where at least one of those respective porosities or pore sizes may be shared across multiple, but not all layers). While depiction 945 shows all respective sublayers as having the same thickness, the respective sublayer thicknesses of a porous layer 120 need not be the same. In some embodiments, a composite radiative cooling material including five sublayers of respective UHMWPE films has a reflectance greater than 90% at all wavelengths below 1500 nm (or between 250 nm and 1500 nm), a reflectance greater than 80% at all wavelengths below 2250 nm (or between 250 nm and 2250 nm), and a reflectance greater than 60% at all wavelengths below 2500 nm (or between 250 nm and 2500 nm).

In some embodiments, composite radiative cooling materials of this disclosure may include stacked arrangements of porous materials that are configured based at least in part on the stacking-versus-reflectance trend shown in depiction 900 or 945. For example, a composite radiative cooling material of this disclosure may include a porous layer 120 that includes a number of sublayers that is configured based on a target reflectance of the composite radiative cooling material.

In some embodiments, there may be a sublayer of, e.g., a polyacrylic adhesive sublayer or any other suitable adhesive sublayer, between each porous sublayer (or between select sublayers) of multiple stacked sublayers of the UHMWPE material or any other stacked porous material of a porous layer.

In some embodiments, composite radiative cooling materials of this disclosure, or at least one layer thereof, may exhibit one of the wavelength-dependent reflectances shown in FIGS. 9A and 9B. Any of the materials with properties exhibited in FIGS. 9A-9B may be a whole or part of porous layer 120.

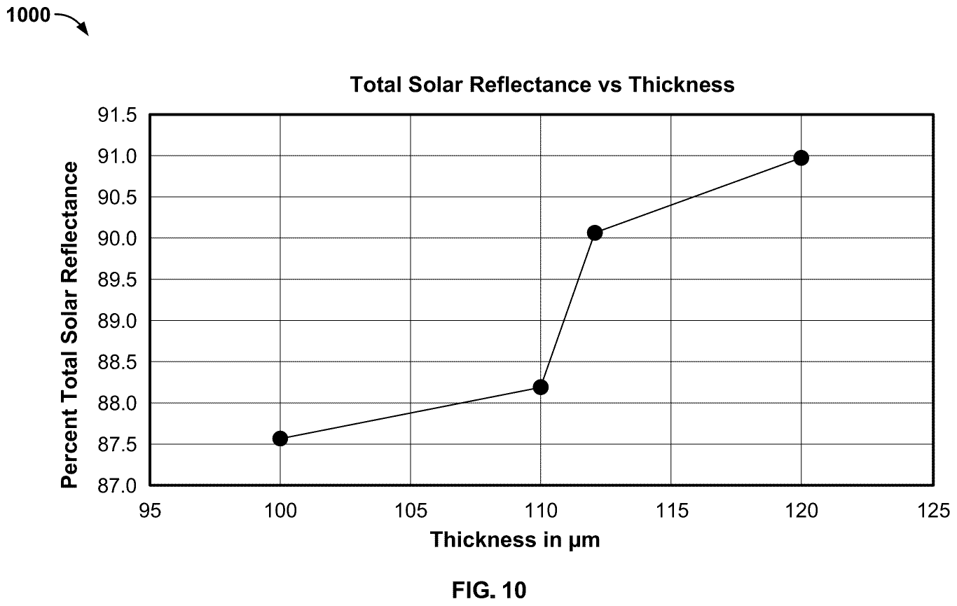

FIG. 10 shows illustrative total solar reflectances of illustrative UHMWPE layers as a function of the total layer thickness in accordance with some embodiments of the present disclosure. The four data points (as indicated by dots) of depiction 1000 may correspond to averaging the respective reflectance data across the total solar energy spectrum for the four curves of depiction 900. As shown, the total solar reflectance of the layer can be increased by increasing the thickness of the layer by adding any one of (i) a single 0.5 mil thick (specifically, e.g., a 10 μm thick film) sublayer with a 20 nm typical pore size, (ii) a single 0.5 mil thick (specifically, e.g., a 12 μm thick film) sublayer with a 50 nm typical pore size, or (iii) a single 1 mil thick (specifically, e.g., a 20 μm thick film) sublayer with a 100 nm typical pore size (e.g., any of which can be called the second sublayer) on top of a single 4 mil thick sublayer with a 500 nm typical pore size (e.g., which can be called the first sublayer) to make a layer of a composite radiative cooling material with greater than 4 mil total thickness. In some embodiments, other first and second sublayers are arranged within a composite radiative cooling material to (at least in part) cause the composite radiative cooling material to exhibit a target solar reflectance, a target thermal emissivity, or a target combination thereof.

In some embodiments, composite radiative cooling materials of this disclosure, or at least one layer thereof, may exhibit at least the total solar reflectance shown in any of the data points of FIG. 10. Any of the materials with properties exhibited in FIG. 10 may be a whole or part of porous layer 120.

In some embodiments, porous layer 120 of composite radiative cooling material 100 may be any of the materials identified in FIGS. 2-4, FIGS. 7-10, or Table 1. In some embodiments, porous layer 120 may exhibit any of the optical properties shown in FIGS. 2-4, FIGS. 7-10, or Table 1. In some embodiments, emissive layer 110 of composite radiative cooling material 100 may be any of the materials identified in FIGS. 5-6 or Table 4. In some embodiments, emissive layer 110 of composite radiative cooling material 100 may exhibit any of the optical properties shown in FIGS. 5-6 or Table 4. In some embodiments, reflective layer 130 of composite radiative cooling material 100 may be any of the materials identified in Table 5. In some embodiments, reflective layer 130 of composite radiative cooling material 100 may exhibit any of the optical properties shown in Table 5.

In some embodiments, methods are provided to seal or block the top, bottom, or side surfaces, or any combination thereof, of the porous layer of the composite radiative cooling material. The corresponding composite radiative cooling materials can include a porous layer (e.g., porous layer 120) with unfilled pores (i.e., the respective pores remain voided) even though the porous material is in direct contact with a different layer of the composite radiative cooling material. The porous layer may be arranged and/or configured such that any different material or layer in contact with the porous layer does not penetrate (or minimally penetrates, such that optical properties of the porous material are not substantively affected) the voids of the porous material. For example, as provided to improve bond strength to an adhesive, a corona treatment, plasma treatment, chemical treatment, other surface treatment, or any combination thereof, may also be provided to treat a porous layer material and prevent an adjacent layer material (i.e., a material that is arranged directly above or below the porous layer) from filling the pores of the porous layer. In some embodiments, the adjacent layer material may be configured to have a similar refractive index to that of the porous material.

As mentioned, a heat treatment, a plasma treatment, or both may be applied to prevent (e.g., by sealing, blocking, or both) pores of the porous layer from being filled with material from any other layer of the radiative cooling material. For example, treating the composite radiative cooling material by exposure to corona plasma (as further described below) may prevent filling of the pores of the porous layer. For another example, treating the composite radiative cooling material (e.g., with or without arranging a top coat, such as a sealant, as a top layer) by heating may prevent filling of the pores of the porous material. For yet another example, treating the composite radiative cooling material (e.g., with or without arranging a top coat, such as a sealant, as a top layer) by exposure to ultraviolet light may prevent filling of the pores of the porous material.

In some embodiments, a non-porous film of PE, PET, polycarbonate or any other substrate material (e.g., arranged as a film having a thickness of 100 μm or less, or 20 μm or less), may be arranged as a layer of the composite radiative cooling material, and may be thermally or chemically bonded to at least one other layer of the composite radiative cooling material. In some embodiments, a viscous material (e.g., a pressure-sensitive adhesive (PSA)) may be arranged as a layer of the composite radiative cooling material. In some embodiments, a hydrophobic material may be arranged as a layer of the composite radiative cooling material, and this hydrophobic material layer may be formed by curing the hydrophobic material by applying heat, applying UV radiation, or waiting for a predetermined amount of time (e.g., in the case of a self-curing hydrophobic material). As a result of the curing, the hydrophobic material may form a hard coat layer of the radiative cooling material. In some embodiments, the hard coat layer may be a top layer of the radiative cooling material, and the hard coat layer may be configured to be visibly transparent and thermally emissive. Thus, emissive layer 110 may, in some embodiments, be a hard coat layer.

In some embodiments, in addition to exhibiting high solar reflectance, the porous layer 120 (e.g., a porous layer which may include hydrophobic and/or non-polar voided plastics such as PE, UHMWPE, any aliphatic hydrocarbon, any other suitable plastic, or any combination thereof) may exhibit a standalone thermal emissivity that can be improved through integration into a composite radiative cooling material to further serve radiative cooling applications. In some embodiments, micro-voided (i.e., having an average void size of at least 1 μm and less than 1 mm) plastics such as PE, UHMWPE, any aliphatic hydrocarbon, or any combination thereof are used as the porous layer 120. In some embodiments, to increase the emissivity of composite radiative cooling materials including a porous layer without reducing the reflectivity of the porous layer, a highly emissive film (e.g., that is transparent in the visible portion, UV portion, or both portions of the electromagnetic spectrum) may be arranged as another layer of the composite radiative cooling material. For example, materials that exhibits a suitable transparency (i.e., based on a suitable transmittance of at least visible light) and emissivity for use as a top coat layer may include polycarbonate, PET, acrylic or acrylate hard coats, PVDF, silicone, silicon dioxide, and microscale glass spheres. Tables 2-4 and FIG. 5 show some nonlimiting and illustrative examples of emissive materials that can serve as a top coat layer.

In some embodiments, the porous layer 120 may not be UV stable. Thus, top, bottom, or side surfaces, or any combination thereof, of the porous material can be coated with a protective film (which may itself be considered as a layer or sublayer, e.g., if applied over the top or bottom surface of the porous material). In some embodiments, the protective film may be a non-penetrating (e.g., with respect to pores of the porous material) UV stable hard coat (e.g., an emissive layer 110 may additionally function as a protective film for the porous layer 120). In some embodiments, the protective film may be a non-penetrating UV-absorbing (e.g., as shown in FIG. 6) or UV-reflecting coating, the use of which would also provide UV protection to the adjacent porous material. As used throughout this disclosure, non-penetrating may be used to describe any first material that can be applied over a second material (e.g., a nanoporous or microporous material) without filling voids, pores, or other openings of the material.

In some embodiments, the abovementioned techniques for arranging layers of a composite radiative cooling material, including but not limited to arranging an emissive layer 110 over a porous layer 120 and arranging the porous layer 120 arranged over a reflective layer 130, treating material of a porous layer 120 to prevent filling of the pores, treating any layer to improve the bond strength of an adhesive that is applied to a surface of the layer, or any combination thereof, may be used to manufacture a composite radiative cooling material with any of the cross-sectional schematics shown in FIGS. 11-15.

FIG. 11 shows illustrative cross-sectional schematics of composite radiative cooling materials 1110, 1120, and 1130 in accordance with some embodiments of the present disclosure. Composite radiative cooling material 1110, from the top to the bottom of the cross-section as shown, includes emissive layer 1112, which is a hard coat (e.g., that is visibly transparent, thermally emissive, or both), adhesive layer 1114 (e.g., a UV-absorbing adhesive, or a transparent adhesive), porous layer 1116 (e.g., a voided layer with a thickness greater than 200 μm), and reflective layer 1118 (e.g., a base PET layer which may also serve as a substrate). Composite radiative cooling material 1120, from the top to the bottom of the cross-section as shown, includes emissive layer 1122, which is a hard coat (e.g., that is visibly transparent, thermally emissive, or both), adhesive layer 1124 (e.g., a UV-absorbing adhesive, or a transparent adhesive), second reflective layer 1125 (e.g., including PET, any of the other illustrative materials listed in Table 5, or any combination thereof), porous layer 1126 (e.g., a voided layer with a thickness greater than 200 μm), and first reflective layer 1128 (e.g., a base PET layer which may also serve as a substrate). Composite radiative cooling material 1130, from the top to the bottom of the cross-section as shown, includes emissive layer 1132, which is a hard coat (e.g., that is visibly transparent, thermally emissive, or both), third reflective layer 1133 (e.g., any suitable UV reflector), adhesive layer 1134 (e.g., a UV-absorbing adhesive, or a transparent adhesive), second reflective layer 1135 (e.g., including PET, any of the other illustrative materials listed in Table 5, or any combination thereof), porous layer 1136 (e.g., a voided layer with a thickness greater than 200 μm), and first reflective layer 1138 (e.g., a base PET layer which may also serve as a substrate).

As shown in FIG. 11, any first reflective layer (e.g., below a respective porous layer, as shown), may be arranged to prevent moisture from entering the porous layer. Each radiative cooling material of FIG. 11 includes a porous layer that may be a micro-voided layer, a nano-voided layer, or a combination thereof (e.g., a layer including respective microporous and nanoporous sublayers).

Composite radiative cooling materials 1110, 1120, and 1130 may each be considered an embodiment of composite radiative cooling material 100. For example, the respective hard coat layers shown in FIG. 11 may correspond to emissive layer 110, the respective porous layers shown in FIG. 11 may correspond to porous layer 120, and the respective bottom reflective layers shown in FIG. 11 may correspond to reflective layer 130. The adhesive layers shown in FIG. 11 may be regarded as additional layers, or as sublayers (e.g., of an emissive layer 110). Similarly, the respective second reflective layers (e.g., as shown in composite radiative cooling materials 1120 and 1130) and third reflector layer (e.g., as shown in composite radiative cooling material 1130) may be regarded as additional layers, or as sublayers (e.g., of an emissive layer 110).

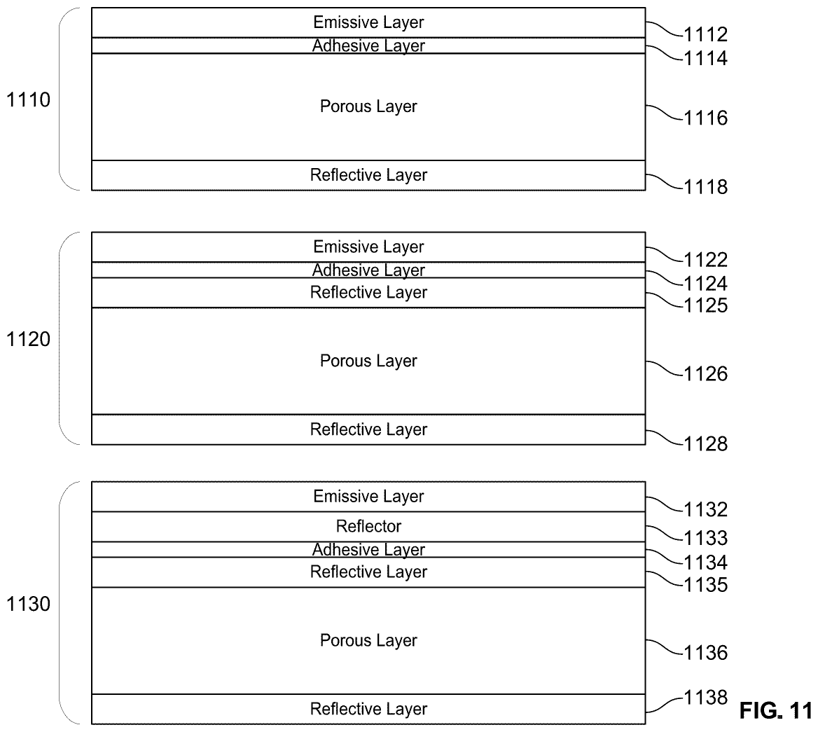

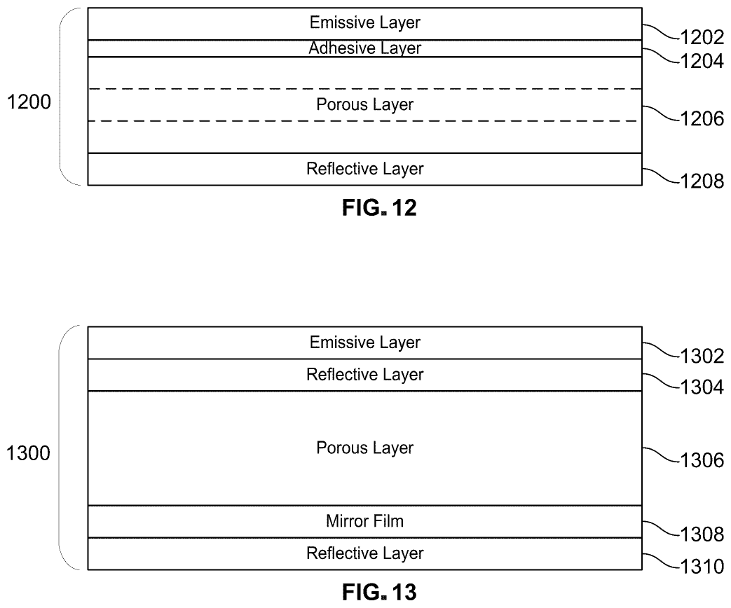

FIG. 12 shows an illustrative cross-sectional schematic of composite radiative cooling material 1200 including a porous layer with multiple porous sublayers in accordance with some embodiments of the present disclosure. Composite radiative cooling material 1200, from the top to the bottom of the cross-section as shown, includes emissive layer 1202, which is a hard coat (e.g., visibly transparent, thermally emissive, or both), adhesive layer 1204 (e.g., a UV-absorbing adhesive, or a transparent adhesive), porous layer 1206 (e.g., including N sublayers of voided films as indicated by the dashed lines, where N may be determined based on the results of FIGS. 9-10, may be set to achieve target optical properties, may be based on any other suitable criteria, or may be based on any combination thereof), and reflective layer 1208 (e.g., a base PET layer which may also serve as a substrate). For example, emissive layer 1202 plus adhesive layer 1204 may correspond to emissive layer 110; porous layer 1206 may correspond to porous layer 120; and reflective layer 1208 may correspond to reflective layer 130.

In some embodiments, each of the multiple voided sublayers of porous layer 1206 may include one or more non-woven materials. These multiple voided layers may be used (e.g., in an integration of non-woven materials) to generate pores with configurable sizes between 10 nm to 1000 nm. In some embodiments, the porous layer 1206 includes multiple voided sublayers to exhibit a porosity greater than 50%.

In some embodiments, each of the respective adhesive layers shown in FIGS. 11-12 (and optionally any other intervening materials between a respective hard coat layer and a respective voided layer) may be considered a sublayer of the annotated porous layer (e.g., the corresponding porous layer includes, as sublayers, the voided material, the adhesive, and optionally any of the other materials arranged below the emissive layer material and above porous layer material). In some embodiments, each of the respective adhesive layers shown in FIGS. 11-12 (and any intervening films between a respective adhesive layer and a porous layer) may be considered a sublayer of the emissive layer (e.g., the corresponding emissive layer includes, as sublayers, the hard coat material, the adhesive, and optionally any of the other arranged below the emissive layer material and above porous layer material). In some embodiments, any emissive layer of FIGS. 11-12 (e.g., each of which may be an emissive layer 110) may be arranged and/or configured, with the underlying adhesive layer (e.g., which may itself be considered a sublayer of the emissive layer), such that the emissive layer and the adhesive together contribute suitable optical properties for radiative cooling applications relying on the corresponding composite radiative cooling material.

FIG. 13 shows an illustrative cross-sectional schematic of a composite radiative cooling material 1300 with a mirror film in accordance with some embodiments of the present disclosure. Composite radiative cooling material 1300, from the top to the bottom of the cross-section as shown, includes emissive layer 1302, which is a hard coat (e.g., that is visibly transparent, thermally emissive, or both), third reflective layer 1304 (e.g., any suitable UV reflector), porous layer 1306 (e.g., which may correspond to any porous layer of FIGS. 11-12), mirror film layer 1308 (e.g., a second reflective layer), and first reflective layer 1310 (e.g., a base PET layer which may also serve as a substrate). For example, the mirror film may be any film that reflects at least a substantial portion of the visible spectrum, such as any suitable metallic film. In some embodiments, the mirror film may include at least two sublayers, where a bottom sublayer of the mirror film includes a polymer or any other suitable substrate material and a top sublayer of the mirror film includes a metal film (e.g., aluminum, silver, or gold), with the metal film causing the mirror film to exhibit high reflectivity of solar radiation.

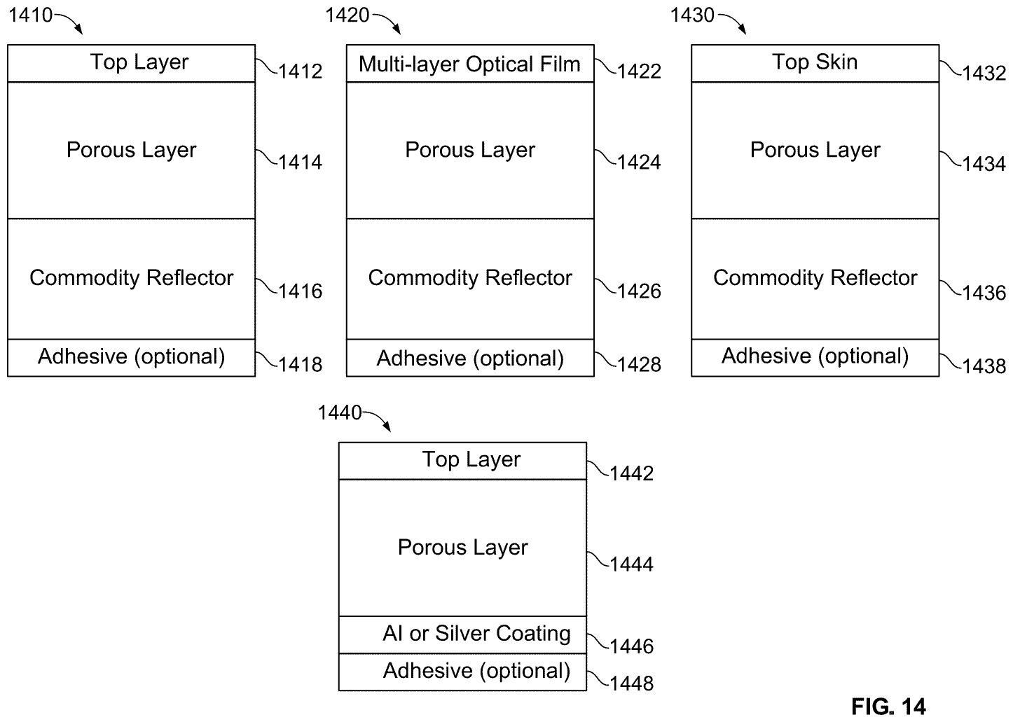

FIG. 14 shows illustrative cross-sections of various arrangements of composite radiative cooling materials in accordance with some embodiments of the present disclosure. As shown in FIG. 14, each respective porous layer may correspond to any of the illustrative porous layers of Table 1 or FIGS. 2-4 and may be a porous layer 120; each respective commodity reflector may correspond to any of the illustrative reflective layers of Table 5 and may be a reflective layer 130; and each respective top layer (e.g., including top layer 1412, top layer 1442, multi-layer optical film 1422 (which is an illustrative type of top layer), and top skin 1432 (which is another illustrative type of top layer)) may correspond to any of the illustrative emissive layers of Tables 2-4 or FIG. 5 and may be an emissive layer 110.

In some embodiments, a commodity reflector as shown in FIG. 14 is used as the base layer of a composite radiative cooling material, and this layer may be arranged above an optional adhesive layer. The optional adhesive layer may, e.g., adhere the composite radiative cooling material to a substrate, to a panel, or to any surface that requires cooling, such as a surface of a building, vehicle, or enclosure, or a heat exchanger. As mentioned, the composite radiative cooling material may itself be a radiative cooling film, with the adhesive mechanically and thermally coupling the radiative cooling film to the substrate, to the panel, to the surface requiring cooling, or to any other suitable load.

The commodity reflector typically exhibits a total solar reflectance of 80-90%, and this reflector may be provided among multiple layers of a composite radiative cooling material to provide a more optimal structure for cooling applications. In addition to those mentioned above, further examples of the commodity reflector include PET (or any other polymer film) with an aluminum reflective coating; a silver layer (e.g., as may be applied to PET or to any other polymer layer); white PET, or any other polymer material, loaded with BaSO₄, TiO₂, or both; white PET, or any other polymer material, having voids; any of the aforementioned materials impregnated with a UVA (e.g., including the blue-shifted and typical UVAs shown in FIG. 6) (e.g., as particles impregnated in a layer or sublayer) to improve the UV resistance of the composite radiative cooling material in outdoor applications; or a reflective metal (e.g., silver or aluminum) coating. In some embodiments, as mentioned when connecting the commodity reflector to the materials of Table 5, the commodity reflector may be a white roofing material such as TPO, PVC, any other white roofing material, or any combination thereof.

As shown in FIG. 14, a porous layer may be provided on top of (e.g., on the sun- or sky-facing side, in an installed orientation for radiative cooling of a load) the commodity reflector. By itself, the porous layer may exhibit a sufficient reflectance to serve cooling applications when a certain combination of porosity, pore size and thickness is configured. For example, the porous layer may exhibit highly reflective and highly transmissive (or non-absorbing) optical properties. In some embodiments, the porous layer may be highly transmissive of select wavelengths that are not strongly reflected by the porous layer (e.g., such that all wavelengths of interest may be strongly reflected or transmitted, but not absorbed).

FIG. 14 includes composite radiative cooling material 1410, which includes, from top to bottom as shown, top layer 1412 (e.g., an emissive layer 110), porous layer 1414, commodity reflector 1416 (e.g., a reflective layer 130), and optional adhesive layer 1418. Porous layer 1414, commodity reflector 1416, and optional adhesive layer 1418 may be the same as or similar to the porous layer, commodity reflector, and optional adhesive layer, respectively, as are provided in some or all of composite radiative cooling materials 1420, 1430, and 1440.

FIG. 14 includes composite radiative cooling material 1420, which includes, from top to bottom as shown, multi-layer optical film 1422 (e.g., an emissive layer 110), porous layer 1424, commodity reflector 1426 (e.g., a reflective layer 130), and optional adhesive layer 1428. multi-layer optical film 1422 may serve as a layer that is both reflective and emissive, e.g., based on being configured to provide high reflectance in the UV portion of the solar spectrum, high transmittance in the non-UV portion of the electromagnetic spectrum, and high emissivity in the far infrared portion of the electromagnetic spectrum. Additional properties that multi-layer optical film 1422 can provide to composite radiative cooling material 1420 include hard coat and anti-soiling properties. In some embodiments, composite radiative cooling material 1420 also includes a fourth layer of an emissive film (e.g., the emissive film including any of the emissive layer materials listed in Table 4) coated over a top surface of multi-layer optical film 1422. For example, applying the emissive film as a top coat of multi-layer optical film 1422 may cause the emissive film and multi-layer optical film 1422 to together contribute suitable optical properties for using composite radiative cooling material 1420 in radiative cooling applications.

FIG. 14 includes composite radiative cooling material 1430, which includes, from top to bottom as shown, top skin 1432 (e.g., an emissive layer 110), porous layer 1434, commodity reflector 1436 (e.g., a reflective layer 130), and optional adhesive layer 1438. The top skin 1432 may mechanically close off pores of the porous layer 1434 to prevent filling of these pores, as mentioned above and as further described below.

As mentioned above and as may pertain to the radiative cooling materials of FIG. 14, as well as those of FIG. 1, FIGS. 11-13, and FIG. 15, a portion of the radiative cooling performance is exhibited due to the porosity of the porous layer 120, including that this porosity extends to the top and bottom surfaces of the film. For example, top and bottom surfaces of porous layer 120 may include a solid material (e.g., any of the plastics listed in Table 1 or described in connection with Table 1) and voids in the solid material. To improve the optical properties of the composite radiative cooling material as compared to those of a standalone porous layer, the top layer (e.g., including the multi-layer optical film, top skin, or any other sky-facing layer) of the composite radiative cooling material may include or may itself be a coating that provides UV-protection to the underlying layers and high emissivity in the far infrared (e.g., 8.0-13.0 μm) spectrum.

When applied over the porous layer, the top layer must not significantly penetrate the pores. In some embodiments, a minimum or negligible amount of penetration of the voids of the porous material may be achieved by using a water-based top layer in conjunction with a hydrophobic porous material. In other embodiments, the top layer may be rendered non-penetrating of the porous layer by having colloids (e.g., which may be μm-scale) that are sufficiently large to block the upper-most pores (e.g., which may be nm-scale) of the porous layer film, thus preventing further penetration of the top layer material into the porous layer film. In other embodiments, the pores may be closed by mechanical means such as by melting the top-most volume of the nanoporous film (e.g., to reduce the size of the top pores, without bringing this size down to zero), or by adhering a top skin layer (e.g., such as top skin 1432) over the pores. Closing off the pores of the bottom side of the nanoporous film may also be desirable to prevent moisture from entering the film (e.g., where the bottom reflective layers shown in FIGS. 11-13, as well as the commodity reflectors of FIG. 14, may prevent moisture from entering the bottom side of the nanoporous film). All the aforementioned approaches used to apply a film or layer over a top of a porous layer may also be used to apply a film or layer under a bottom side of the porous layer. A top skin layer, bottom skin layer, or both, may also have the properties of UV-absorption, high transparency in the visible and near infrared spectra, and high emissivity.

Optionally, the top layer (e.g., as shown in FIG. 14 and elsewhere in this disclosure, and which may correspond to emissive layer 110) may also provide mechanical protection of the underlying film (i.e. “hard coat” properties such as scratch resistance, abrasion resistance, etc.). Optionally, the top layer may otherwise or additionally provide anti-soiling properties which improve the ability of the film to stay clean and free of debris, dust, other matter that may disrupt the optical properties of the composite radiative cooling material, or any combination thereof.

FIG. 14 also includes composite radiative cooling material 1440, which includes, from top to bottom as shown, top layer 1442 (e.g., an emissive layer 110), porous layer 1444, aluminum or silver coating 1446 (e.g., which may be a mirror film such as is shown in FIG. 13, and which may correspond to reflective layer 130), and optional adhesive layer 1448. As represented by the relative thicknesses (not to scale), the aluminum or sliver coating 1446 may be thinner than any commodity reflector shown in FIG. 14 and may therefore reduce a total size of composite radiative cooling material 1440 (e.g., compared to composite radiative cooling material 1410).

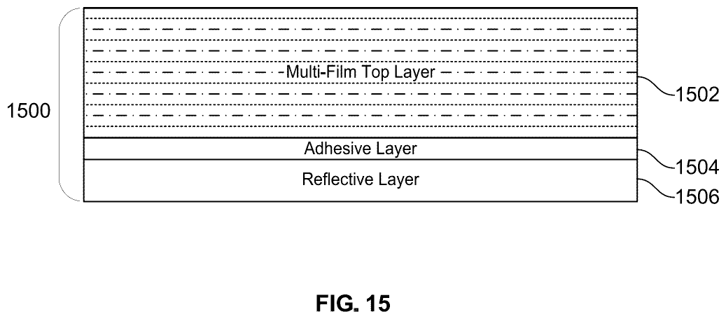

FIG. 15 shows an illustrative cross-section of composite radiative cooling material 1500 including a multi-film top layer 1502 in accordance with some embodiments of the present disclosure. Composite radiative cooling material 1500 includes, from top to bottom as shown, the multi-film top layer 1502 (e.g., a whole or part of an emissive layer 110, which may be further configured to reflect greater than 50% of incident ultraviolet radiation), adhesive layer 1504, and reflective layer 1506 (e.g., a reflective layer 130). In some embodiments, multi-film top layer 1502 includes a stack of alternating sublayers, the alternating sublayers including respective sublayers of a first material (e.g., as indicated by the short-dashed lines) and respective sublayers of a second material (e.g., as indicated by the dot-dashed lines). These alternating sublayers (of which there may be any suitable number) may be configured to increase the solar reflectivity of composite radiative cooling material 1500, provide suitable emissivity, protect the reflector layer 1506, or any combination thereof. In some embodiments, multi-film top layer 1502 may correspond to multi-layer optical film 1422. As such, multi-layer optical film 1422 may be an emissive material (e.g., of an emissive layer 110), and the emissive material of multi-layer optical film 1422 may include alternating sublayers associated with respective first and second materials (e.g., with the respective first and second materials being selected, arranged, configured, or any combination thereof to provide suitable emissivity and reflectivity).

The following describes how composite radiative cooling material 1500 may be an embodiment of composite radiative cooling material 100 (or other composite radiative cooling materials described in this disclosure, including at least those of FIGS. 11-14 and Table 6). In some embodiments, reflective layer 1506 may include or itself be a porous polymer (e.g., any of the porous polymers described in this disclosure, including at least those shown in Table 1 and FIGS. 2-4). Thus, a portion of reflective layer 1506 may correspond to porous layer 120. For example, reflector layer 1506 may include a porous sublayer (e.g., which may constitute porous layer 120), and pores of this porous sublayer may be configured to extend to the top surface of reflector layer 1506 but not to the bottom of reflector layer 1506, such that reflector layer 1506 may include a reflective sublayer (e.g., which may constitute reflective layer 130, and which may be impregnated by the light-scattering particles) that is arranged under the porous sublayer of reflector layer 1506. In some embodiments, reflective layer 1506 (e.g., as a porous polymer, or otherwise) may be at least partially impregnated with light-scattering particles, such as TiO₂, BaSO₄, CaCO₃, or any other suitable colloids.

It is noted that the cross-sections shown in FIGS. 11-15 are not drawn to scale. In some embodiments, the relative layer thicknesses (including sublayer thicknesses) of the cross-sections shown in FIGS. 11-15 may correspond to the relative thicknesses of as-manufactured corresponding composite radiative cooling materials. However, composite radiative cooling materials that are provided in accordance with embodiments of this disclosure need not follow any of the relative thicknesses shown in the illustrative cross-sections of FIGS. 11-15.

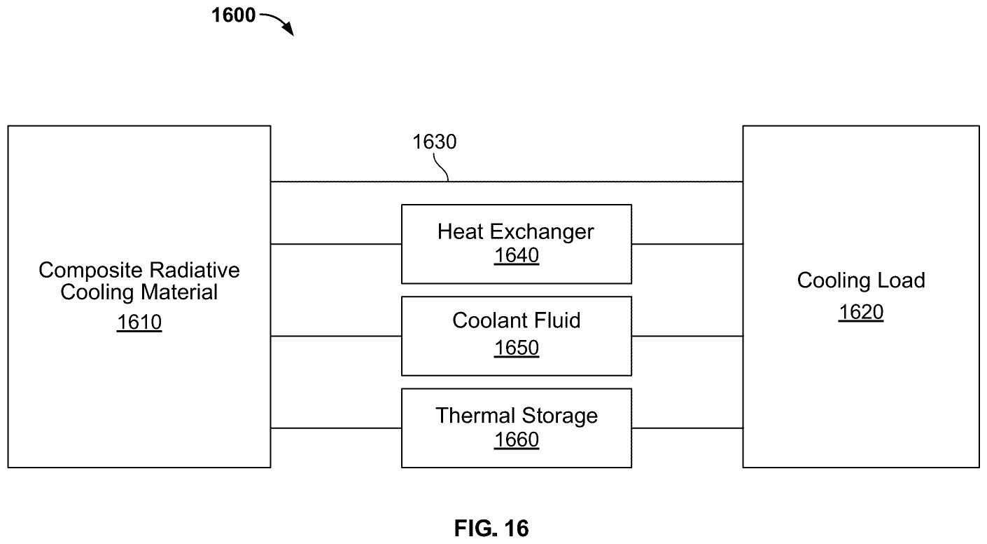

FIG. 16 shows an illustrative cooling system 1600 including composite radiative cooling material 1610 in accordance with some embodiments of the present disclosure. Composite radiative cooling material 1610 may be any of the composite radiative cooling materials described in this disclosure, including at least those of FIG. 1, FIGS. 11-15, and Table 6; as such, composite radiative cooling material 1610 may be configured to include at least three layers (e.g., reflective layer 130 having a reflective material, porous layer 120 having a porous material, and emissive layer 110 having an emissive material), where an arrangement of the three layers causes composite radiative cooling material 1610 to exhibit a total solar reflectance greater than 85%, and a thermal emissivity greater than 85% in the wavelength range of 8.0 to 13.0 μm.

Composite radiative cooling material 1610 is arranged to cool any cooling load 1620 based on being thermally coupled to the cooling load and based on the optical properties exhibited by composite radiative cooling material 1610. In some embodiments, composite radiative cooling material is thermally coupled to cooling load 1620 via heat exchange interface 1630. Heat exchange interface 1630 may be any suitable thermal conductor that causes heat radiated off of composite radiative cooling material 1610 to be drawn from cooling load 1620 (i.e., a temperature of cooling load 1620 is reduced based on conduction through the heat exchange interface 1630 and thermal emission from composite radiative cooling material 1610). For example, cooling load 1620 may be inside a building, vehicle, or enclosure (e.g., any electronic enclosure), heat exchange interface 1630 may be a roof or other sky-facing surface of the building, vehicle, or enclosure, and composite radiative cooling material 1610 may be arranged to provide cooling to cooling load 1620 based on being applied over the roof or other sky-facing surface. As used herein, cooling load 1620 being inside a building, vehicle, or enclosure could mean that cooling load 1620 is an internal volume of the building, vehicle, or enclosure, cooling load 1620 is any heat-generating object inside the internal volume of the building, vehicle, or enclosure, or cooling load 1620 is any combination thereof.

In some embodiments, composite radiative cooling material 1610 may, in place of or in addition to heat exchange interface 1630, be thermally coupled to cooling load 1620 via one or more of a heat exchanger 1640, coolant fluid 1650, or thermal storage 1660. For example, composite radiative cooling material 1610 may be arranged to cool the heat exchanger 1640, coolant fluid 1650, thermal storage 1660, or any combination thereof, where the heat exchanger 1640, coolant fluid 1650, thermal storage 1660, or any combination thereof is in turn arranged to cool the cooling load 1620.

In some embodiments, cooling load 1620 may be at least one of a refrigerant, a cooling jacket of equipment, a thermal reservoir, a source of heat, an air conditioning system, or a coolant conditioning system.

In some embodiments, composite radiative cooling material 1610 may be thermally coupled to cooling load 1620 based on applying composite radiative cooling material 1610 to a panel, and thermally coupling the panel to the load. For example, the panel may be the heat exchange interface 1630 or heat exchanger 1640. For another example, the panel may be thermally coupled to any one or more of heat exchange interface 1630, heat exchanger 1640, coolant fluid 1650, or thermal storage 1660.

In some embodiments, composite radiative cooling material 1610 may cool an outdoor space, and cooling load 1620 may be a particular portion of outdoor air (e.g., above or surrounding an area covered by composite radiative cooling material 1610). For example, cooling load 1620 may be a heat island (i.e., a portion of outdoor space that can get hotter than the surrounding ambient air under certain solar radiation conditions) within a broader outdoor environment, and composite radiative cooling material 1610 may be arranged to lower a temperature of the heat island to be closer to, if not lower than, an average temperature associated with the surrounding ambient air and the broader outdoor environment.

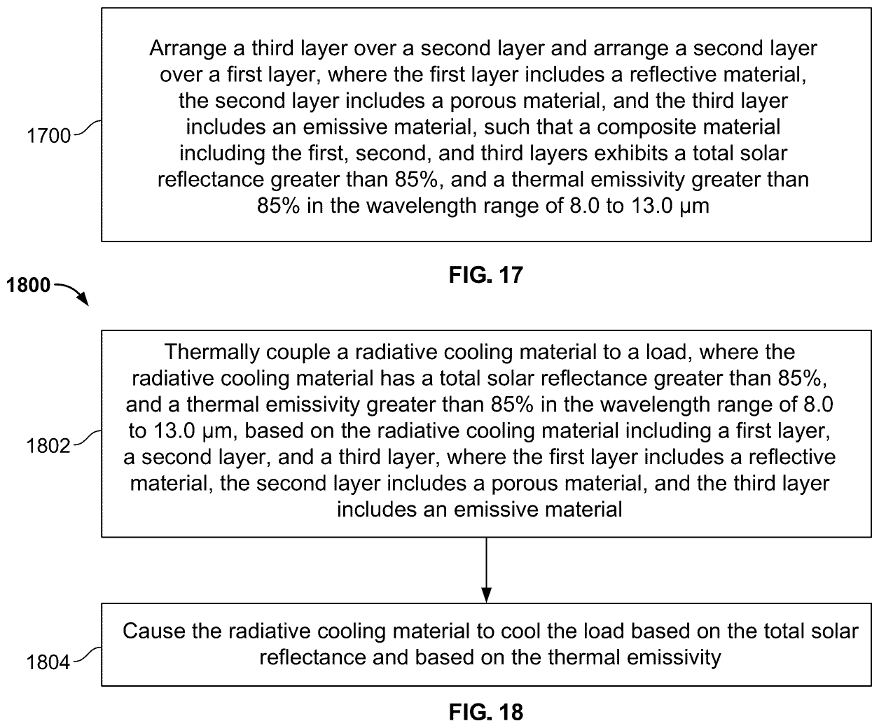

FIG. 17 shows a method 1700 for arranging layers of a composite radiative cooling material in accordance with some embodiments of the present disclosure. Method 1700 includes arranging a third layer (e.g., emissive layer 110) over a second layer (e.g., porous layer 120) and arranging a second layer over a first layer (e.g., reflective layer 130), where the first layer includes a reflective material, the second layer includes a porous material, and the third layer includes an emissive material, such that a composite material (e.g., composite radiative cooling material 100) including the first, second, and third layers exhibits a total solar reflectance greater than 85% and a thermal emissivity greater than 85% in the wavelength range of 8 to 13 μm. For example, method 1700 may be used to arrange any of the composite radiative cooling materials shown in FIG. 1, FIGS. 11-16, or Table 6, or any other composite radiative cooling material that is consistent with the subject matter of this disclosure.

In some embodiments, method 1700 also includes coupling an adhesive (e.g., any adhesive layer described in this disclosure, including at least those shown in FIGS. 11 and 12) to a respective side of the second layer, where the adhesive adheres the second layer to the first layer or to the third layer, respectively.

In some embodiments, method 1700 also includes coupling an adhesive (e.g., any adhesive layer described in this disclosure, including at least those shown in FIG. 14) to the third layer, where the third layer and the adhesive collectively exhibit a thermal emissivity greater than 85% in a wavelength range of 8 to 13 μm.

In some embodiments, in connection with the abovementioned surface treatments (e.g., including a corona treatment, plasma treatment, chemical treatment, or any combination thereof) to prevent material from penetrating the pores of the porous material, method 1700 also includes arranging the third layer over the second layer and arranging the second layer over the first layer comprises arranging the third layer, the second layer, and the first layer such that neither the first layer nor the third layer penetrates the porous material of the second layer. In some embodiments, method 1700 also includes arranging pores of the porous material between a top surface and a bottom surface, inclusive, along a thickness dimension of the porous material. Thus, method 1700 may include the porous material being arranged and/or configured such that pores of the porous material extend to the top and bottom surfaces of the material.

In some embodiments, method 1700 also includes configuring a thickness of the porous material (e.g., based on the results listed in Table 1, or the results shown in FIGS. 9-10) to exhibit the thermal emissivity greater than 85% in the wavelength range of 8 to 13 μm.

In some embodiments, method 1700 also includes arranging a UV absorber, such as a blue-shifted UV absorber (e.g., as shown in FIG. 6), within the third layer. For example, the UV absorber may exhibit greater than 90% transmittance of solar radiation at wavelengths greater than 405 nm, and less than 5% transmittance of solar radiation at wavelengths less than 365 nm. For another example, the blue-shifted UV absorber may exhibit greater than 90% transmittance of solar radiation at wavelengths greater than 380 nm and less than 5% transmittance of solar radiation at wavelengths less than 325 nm.

In some embodiments, method 1700 also includes arranging a UV reflector, such as any of the colloid particles mentioned above, within the third layer. For example, arranging the UV reflector may include impregnating material of the third layer with TiO₂, BaSO₄, CaCO₃, or any other suitable colloids, where the colloid size may be configured based on a target reflectivity, based on an ability to block pores (i.e., due to being larger than the pores) of the porous material, or based on both of those factors.

FIG. 18 shows a method 1800 for radiative cooling using a composite radiative cooling material in accordance with some embodiments of the present disclosure. Method 1800 includes step 1802 of thermally coupling a radiative cooling material (e.g., composite radiative cooling material 100, composite radiative cooling material 1610, any of the composite radiative cooling materials shown in FIGS. 11-15, or any other composite radiative cooling material consistent with the subject matter of this disclosure) to a load (e.g., cooling load 1620), where the radiative cooling material has a total solar reflectance greater than 85% and a thermal emissivity greater than 85% in the wavelength range of 8.0 to 13.0 μm based on the radiative cooling material including a first layer, a second layer, and a third layer, where the first layer includes a reflective material, the second layer includes a porous material, and the third layer includes an emissive material. Method 1800 also includes step 1804 of causing the radiative cooling material to cool the load based on the total solar reflectance and based on the thermal emissivity.

In some embodiments, method 1800 includes thermally coupling the composite radiative cooling material to the cooling load using any one or more of heat exchange interface 1630, heat exchanger 1640, coolant fluid 1650, or thermal storage 1660.

In some embodiments, a substrate over which a composite radiative cooling material (e.g., composite radiative cooling material 100, composite radiative cooling material 1610, any of the composite radiative cooling materials shown in FIGS. 11-15, or any other composite radiative cooling material consistent with the subject matter of this disclosure) is applied (e.g., via a bottom-layer adhesive, such as is shown in FIG. 14, or via any other suitable attachment mechanism) may be, or may otherwise include, a highly emissive (e.g., black) substrate with an emissivity of, for example, greater than 80% in the wavelength range of 8 to 13 μm. For example, the substrate may be any black-colored material that provides suitable mechanical properties for supporting the composite radiative cooling material. The substrate may also optionally protect the composite radiative cooling material by preventing water from seeping through or into the bottom of the composite radiative cooling material.

The processes described above are intended to be illustrative and not limiting. One skilled in the art would appreciate that the steps of the processes described herein may be omitted, modified, combined, rearranged, or any combination thereof, and any additional steps may be performed without departing from the scope of the invention.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following numbered paragraphs.

What is claimed is:

1. A composite radiative cooling material comprising:
a first layer comprising a reflective material;
a second layer comprising a porous material; and
a third layer comprising an emissive material, wherein:
the composite radiative cooling material exhibits a total solar reflectance greater than 85%, and a thermal emissivity greater than 85% in a wavelength range of 8 to 13 μm.

2. The composite radiative cooling material of claim 1, wherein:
the first layer, the second layer, and the third layer are in a vertically stacked arrangement; and
the third layer is arranged to be capable of directly facing a sky, the second layer is arranged under the third layer, and the first layer is arranged under the second layer.

3. The composite radiative cooling material of claim 1, wherein the reflective material exhibits a total solar reflectance greater than 75%.

4. The composite radiative cooling material of claim 1, wherein the first layer comprises at least one of: white polyethylene terephthalate (PET), white thermoplastic polyurethane, aluminum-coated PET, silver-coated PET, polytetrafluoroethylene, thermoplastic olefin, or polyvinyl chloride.

5. The composite radiative cooling material of claim 1, wherein the porous material comprises a plurality of pores with an average pore size between 100 nm and 1,000 nm.

6. The composite radiative cooling material of claim 1, wherein the porous material comprises a plurality of pores that yield a porosity of the porous material greater than 75%.

7. The composite radiative cooling material of claim 1, wherein the porous material is of a thickness that is at least 0.001 inch.

8. The composite radiative cooling material of claim 1, wherein the porous material comprises at least one of: polyethylene, high molecular weight polyethylene, ultra-high molecular weight polyethylene, polysulfone, polyether sulfone, polyamide, polyethylene terephthalate, or a fluorinated polymer.

9. The composite radiative cooling of claim 1, wherein the porous material exhibits a total solar reflectance greater than 75% and a total solar absorbance less than 5%.

10. The composite radiative cooling of claim 1, wherein pores of the porous material are arranged between a top surface and a bottom surface, inclusive, along a thickness dimension of the porous material.

11. The composite cooling material of claim 1, wherein the second layer further comprises an adhesive layer coupled to a respective side of the second layer.

12. The composite cooling material of claim 11, wherein the adhesive adheres the second layer to the first layer or the third layer, respectively.

13. The composite radiative cooling material of claim 1, wherein the emissive material exhibits a total solar absorption of less than 5%.

14. The composite radiative cooling material of claim 13, wherein the third layer further comprises a UV absorber (UVA), wherein the UVA exhibits:
greater than 90% transmittance of solar radiation at wavelengths greater than 405 nm; and
less than 5% transmittance of solar radiation at wavelengths less than 365 nm.

15. The composite radiative cooling material of claim 13, wherein the third layer further comprises a blue-shifted UV absorber (UVA), wherein the blue-shifted UVA exhibits:
greater than 90% transmittance of solar radiation at wavelengths greater than 380 nm; and
less than 5% transmittance of solar radiation at wavelengths less than 325 nm.

16. The composite radiative cooling material of claim 1, wherein the emissive material comprises at least one of: thermoplastic polyurethane (TPU), polyethylene terephthalate (PET), polycarbonate, polyvinylidene fluoride (PVDF), poly(methyl methacrylate) (PMMA), or cyclic olefin copolymer (COC).

17. The composite radiative cooling material of claim 1, wherein the emissive material comprises a film that exhibits a thermal emissivity greater than 85% in the wavelength range of 8 to 13 μm.

18. The composite radiative cooling material of claim 1, wherein the emissive material comprises a film and the third layer further comprises an adhesive coupled to the film, wherein the film and the adhesive collectively exhibit a thermal emissivity greater than 85% in a wavelength range of 8 to 13 μm.

19. The composite radiative cooling material of claim 1, wherein any layer adjacent to the second layer does not penetrate the porous material.

20. The composite radiative cooling material of claim 1, wherein the third layer is formed based on a deposition of an aqueous film comprising at least one resin of: PVDF, polyurethane, or acrylic.

21. The composite radiative cooling material of claim 1, wherein the third layer comprises a multi-layer optical film, wherein the multi-layer optical film comprises the emissive material and further comprises another reflective material.

22. The composite radiative cooling material of claim 21, further comprising a fourth layer comprising another emissive material, wherein the fourth layer is arranged over the third layer.

23. A method for manufacturing a composite radiative cooling material, the composite radiative cooling material comprising:
a first layer comprising a reflective material;
a second layer comprising a porous material; and
a third layer comprising an emissive material, wherein:
the composite radiative cooling material has a total solar reflectance greater than 85%, and a thermal emissivity greater than 85% in the wavelength range of 8.0 to 13.0 μm; the method comprising:
arranging the third layer over the second layer and arranging the second layer over the first layer.

24. The method of claim 23, further comprising coupling an adhesive to a respective side of the second layer, wherein the adhesive adheres the second layer to the first layer or the third layer, respectively.

25. The method of claim 23, further comprising coupling an adhesive to the third layer, wherein the third layer and the adhesive collectively exhibit a thermal emissivity greater than 85% in a wavelength range of 8 to 13 μm.

26. The method of claim 23, wherein arranging the third layer over the second layer and arranging the second layer over the first layer comprises arranging the third layer, the second layer, and the first layer such that neither the first layer nor the third layer penetrates the porous material of the second layer.

27. The method of claim 23, further comprising configuring a thickness of the porous material, wherein the thickness at least in part causes the composite radiative cooling material to exhibit the thermal emissivity.

28. The method of claim 23, further comprising arranging pores of the porous material between a top surface and a bottom surface, inclusive, along a thickness dimension of the porous material.

29. The method of claim 23, further comprising arranging a UV absorber (UVA) within the third layer, wherein the UVA exhibits:
greater than 90% transmittance of solar radiation at wavelengths greater than 405 nm; and
less than 5% transmittance of solar radiation at wavelengths less than 365 nm.

30. The method of claim 23, further comprising arranging a blue-shifted UV absorber (UVA) within the third layer, wherein the blue-shifted UVA exhibits:
greater than 90% transmittance of solar radiation at wavelengths greater than 380 nm; and
less than 5% transmittance of solar radiation at wavelengths less than 325 nm.

31. A method for cooling a load using a composite radiative cooling material, the composite radiative cooling material comprising:
a first layer comprising a reflective material;
a second layer comprising a porous material; and
a third layer comprising an emissive material, wherein:
the composite radiative cooling material has a total solar reflectance greater than 85% and a thermal emissivity greater than 85% in the wavelength range of 8 to 13 μm; the method comprising:
thermally coupling the radiative cooling material to the load; and
causing the radiative cooling material to cool the load based on the total solar reflectance and based on the thermal emissivity.

32. The method of claim 31, wherein the load is inside a building or vehicle, and thermally coupling the radiative cooling material to the load comprises applying the radiative cooling material to a surface of the building or vehicle that is exposed to a sky.

33. The method of claim 31, wherein thermally coupling the radiative cooling material to the load comprises:
thermally coupling the radiative cooling material to a heat exchanger; and
thermally coupling the heat exchanger to the load.

34. The method of claim 31, wherein thermally coupling the radiative cooling material to the load comprises:
cooling a coolant fluid using the radiative cooling material; and
cooling the load using the coolant fluid.

35. The method of claim 31, wherein the load is at least one of:
a refrigerant;
a cooling jacket of equipment;
a thermal reservoir;
a source of heat;
an air conditioning system; or
a coolant conditioning system.

36. The method of claim 31, wherein thermally coupling the radiative cooling material to the load comprises:
applying the radiative cooling material to a panel; and
thermally coupling the panel to the load.

37. The method of claim 31, wherein the load is a heat island within an outdoor environment, and cooling the load comprises lowering a temperature of the heat island to be closer to an average temperature of the outdoor environment.
